(19) United States
(12) Patent Application Publication
(10) Pub. No.: US 2006/0161392 A1
(43) Pub. Date: Jul. 20, 2006

(54) Food product contamination event management system and method

(75) Inventors: Jeffrey John Sholl, Jackson, WY (US); Andrew Martin Jaine, Rancho Santa Fe, CA (US); Susan Kay Harlander, New Brighton, MN (US)

Correspondence Address: LARSON NEWMAN ABEL POLANSKY & WHITE, LLPL., 5914 WEST COURTYARD DRIVE, SUITE 200, AUSTIN, TX, 78746, US

(73) Assignee: Food Security Systems, Inc., Eden Prairie, MN (US)

(21) Appl. No.: 11/250,855

(22) Filed: Oct. 14, 2005

Related U.S. Application Data
(60) Provisional application No. 60/619,499, filed on Oct. 15, 2004.

(51) Int. Cl. G21C 17/00

(52) U.S. Cl. 702/183

(57) ABSTRACT

An event management system has a first input node, a second input node, and a food event management system. The first input node is adapted to receive epidemiological information. The second input node is adapted to receive food distribution path information. The food event management system is coupled to the first input node and to the second input node. The food event management system is adapted to compare the epidemiological information and the food distribution path information to identify one or more possible correlations and to generate an event output related to the one or more possible correlations.

### CROSS-REFERENCE TO RELATED APPLICATION(S)

This application claims the benefit under 35 U.S.C. §119(e) of earlier filed application Ser. No. 60/619,499 entitled “SYSTEM AND METHOD FOR IDENTIFYING, TRACKING AND REMEDIATING FOOD CONTAMINATION EVENTS,” filed on Oct. 15, 2004 and incorporated herein in its entirety. This application is related to U.S. patent application Ser. No. 10/946,463 filed on Sep. 21, 2004 and entitled “System and method for identifying a food event, tracking the food product, and assessing risks and costs associated with intervention,” which is a continuation of U.S. Pat. No. 6,874,000, entitled “System and method for identifying a food event, tracking the food product, and assessing risks and costs associated with intervention,” filed Oct. 8, 2003.

### BACKGROUND

1. Field of the Disclosure

The present disclosure relates to event management systems, and more particularly, to food contamination event management systems.

2. Description of the Related Art

Generally, large-scale food contamination events occur infrequently. Considering the volume of food ingested every day, more contamination events would be expected than actually occur, which is a tribute to the quality of the food industry. Nevertheless, food contamination events occur, and people become ill from the contaminants. Such illnesses may be referred to as food-borne illnesses.

In the early 1990's, for example, a large batch of ice cream was contaminated with Salmonella. Subsequent investigations revealed that the source of the contamination was a tanker truck, which was used to transport eggs, was inadequately cleaned, and then was used to transport a load of already pasteurized milk to the ice cream manufacturer's facility. The contaminated ice cream was processed, packaged, and distributed to stores and food services. Consumers purchased various contaminated ice cream products, and subsequently some of the consumers consumed the ice cream products. A fraction of those consumers became sick from Salmonella. Statistically, a Salmonella contamination of a large batch of ice cream should result in dilute contaminations on a per serving basis. However, for infants, young children, the elderly, and other people who are susceptible to disease, even a dilute contamination by Salmonella can cause severe illness.

Food-borne illnesses in the United States cause an estimated 76 million illnesses, 325,000 hospitalizations and 5,000 deaths annually, according to the Centers for Disease Control and Prevention (CDC). Currently, more than 200 known diseases are transmitted through food. Causes of food-borne illness may include viruses, bacteria, parasites, toxins, metals, prions, and the symptoms of food-borne illness may range from mild stomach problems to life threatening neurological, hepatic, and renal syndromes. Ongoing changes in the food supply, the identification of new food-borne diseases, and the availability of new surveillance data have made significant gains in reducing the numbers of food-borne illnesses and related deaths.

In the United States, multiple systems exist for surveillance of food-caused illnesses, some of which are also used to identify contamination outbreaks and their causes. A contamination outbreak is defined as two or more cases of a similar illness resulting from ingestion of a common food. The CDC has 18 separate surveillance systems utilized to detect cases or outbreaks of food-borne disease. Four principle systems, the food-borne disease outbreak surveillance system, Pulsenet, FoodNet, and the surveillance outbreak protection algorithm each focus on food-borne diseases and cover more than one agent.

Data sources utilized by the CDC include the food-borne diseases active surveillance network (foodnet), the public health laboratory information system, the gulf coast states Vibrio surveillance system, the food-borne disease outbreak surveillance system, the national ambulatory medical care survey, the national hospital ambulatory care survey, the national hospital discharge survey, the national vital statistics system, and selected published studies.

Foodnet is a collaborative effort by the Centers for Disease Control and Prevention, the U.S. Department of Agriculture, the U.S. Food and Drug Administration, and selected state health departments. Foodnet conducts active surveillance for seven bacterial and two parasitic food-borne diseases within a defined population of 20.5 million Americans. Additionally, surveys conducted within the Foodnet population provide information on the frequency of diarrhea in the general population, the proportion of ill persons seeking care, and the frequency of stool culturing by physicians and laboratories for selected food-borne agents.

The national disease surveillance system and the public health laboratory information system collect national surveillance data for a wide range of diseases reported by physicians and laboratories. The gulf coast states Vibrio surveillance system collects reports of infections from selected states, and the food-borne disease outbreak surveillance system receives data from all states on recognized food-borne illness outbreaks (defined as two or more cases of a similar illness resulting from an ingestion of a common food).

In general, food-borne illness resulting from consumption of any food is dependent on a number of factors. The food product must first be contaminated with a agent, and the agent must survive until the time of consumption at levels sufficient to cause illness. The infectious dose (minimum numbers of organisms necessary to cause infection) is very low in many cases, which means that a microorganism need only contaminate the food and survive without reproducing. For example, pathogenic parasites and viruses are unable to multiply outside of a human or animal host, and only need to survive until ingestion, at which point the parasites or viruses begin to multiply and cause illness.

In some cases, multiplication of pathogens is essential to cause illness in a consumer. Some microorganisms cause illness only when ingested in high numbers (for example, clostridium perfringens), while in other cases the infectious dose is thought to be dependent upon the susceptibility of the individual. Illness due to staphylococcus aureus, bacillus cereus, or clostridium botulinum result from the production of toxins in the food as a byproduct of the multiplying cells. Sometimes, in the absence of viable cells, it is the toxins that are responsible for symptoms of disease. If multiplying cells produce toxins, then toxin production requires favorable cell growth conditions.

Produce can become contaminated with microbial pathogens through a wide variety of mechanisms. Contamination leading to food-borne illnesses has occurred during production, harvest, processing, and transporting, as well as in retail and food service establishments and in the consumer's home. Improper handling and storage of produce prior to consumption can exacerbate contamination from various elements of the food distribution systems. The point of contamination is important because control measures are most effective if geared toward reducing contamination at the source.

The CDC rates surveillance to be the most important tool for detecting and monitoring- both existing and emerging food-borne illnesses. Unfortunately, surveillance of food-borne illness is complicated by many factors including underreporting of illness symptoms. Although food-borne illnesses can be severe or even fatal, mild cases are often not detected through routine surveillance, in part, because those suffering from the symptoms do not seek medical attention. Second, many agents transmitted through food are also spread through water or from person-to-person contact, thus obscuring the role of food-borne transmission. Third, there can sometimes be significant delays between contamination and consumption, for example when the contaminated food item has a long shelf-life. Finally, pathogens or agents may cause some percentage of illnesses that have not yet been identified and thus cannot be diagnosed. The importance of this final factor cannot be overstated. Many of the pathogens of greatest concern today (including Campylobacter jejuni, Escherichia coli 0157:H7, Listeria monocytogenes, Cyclospora cayetanensis, and the like) were not even recognized as causes of food-borne illness just 20 years ago.

Food contamination events are typically not identified immediately, unless the food producer is aware of the contamination. Generally, identification of a food contamination event is complicated by delays. For example, there is often a delay between the purchase and the consumption of the product. There is another delay before the consumer exhibits symptoms of illness. There may be further delays before the consumer seeks medical attention. If the sick consumer seeks medical attention, diagnosis of the source of the contamination-related symptoms takes additional time. Once such a contamination event is identified, the source of the contamination is identified. If a doctor has reason to believe that the product was contaminated at a location other than the consumer's home, a doctor may notify a public health official. At this point, it is left to the public health agency, the official assigned to monitor the potential outbreak, or some other public employee to determine whether the illness outbreak is an isolated incident or an early indication of an outbreak.

Typically, it takes more than one person becoming ill from food contamination before a cause can be determined. Consequently, a public health agency collects a number of data points from various other agencies and health professionals. One or more public health officials assigned to the particular illness look for a pattern among the various data points (including outbreak locations, likely food sources or other contamination sources, and so on) to identify a potential source of the outbreak. The potential contamination sources are then compared with available information (such as information collected from the ill consumer regarding his or her food consumption over the past few days or weeks).

Based on such collected information, the source of the symptoms may be identified (e.g. tainted meat, contaminated or spoiled salad dressing, and so on), and the health official manually can identify where the consumer acquired the tainted product. The health official manually traces back from the source of the symptoms to identify the source of the contamination in the food distribution path (such as farmer, migrant-worker or harvester, processor/manufacturer, transportation, distribution, and so on). Conventionally, such identification is not an easy task, involving multiple unrelated information sources, various databases, and manual determinations. Moreover, such identification is highly dependent on the skill of the public health official.

### BRIEF DESCRIPTION OF THE DRAWINGS

The present disclosure may be better understood, and its numerous features and advantages made apparent to those skilled in the art by referencing the accompanying drawings.

FIG. 1 is a block diagram of an embodiment of a food event system.

FIG. 2 is a block diagram of a food event management system of FIG. 1.

FIG. 3 is an expanded block diagram of the food event management system of FIG. 2.

FIG. 4 is a flow diagram of a method for providing information relating to an evolving food contamination event to a user of the food event management system of FIG. 2.

FIG. 5 illustrates a startup screen of a graphical user interface of the food event management system of FIG. 2.

FIGS. 6-17 illustrate an event detection window of a graphical user interface of the food event management system of FIG. 2.

FIG. 18 illustrates detailed assessment information within an Identification tab of the graphical user interface of the food event management system of FIG. 2.

FIGS. 19-22 illustrate views within a Containment tab of the graphical user interface of FIG. 2.

FIGS. 23 and 24 illustrate views within a Remediation tab of the graphical user interface of FIG. 2.

FIG. 25 is a flow diagram of a method of managing a food event with a food event management system, such as that shown in FIG. 2.

FIG. 26 is a block diagram of the food event management system of FIG. 2 illustrating inputs and outputs.

FIG. 27 is a block diagram of an embodiment of a food event management system.

FIG. 28 is a flow diagram of a method of identifying a correlation between food product distribution paths and illness outbreak locations.

FIG. 29 is a flow diagram of a method of performing trace-forward and trace-backward operations to identify all contamination points in a food distribution path.

FIG. 30 is a flow diagram of a method of identifying a probable source of an illness outbreak using known food distribution paths and known illness outbreak information.

FIG. 31 is a block diagram of a process-based system with which embodiments of the food event management system of FIG. 2 can be used.

The use of the same reference symbols in different drawings indicates similar or identical items.

### DESCRIPTION OF THE DRAWINGS

In one embodiment, an event management system has a first input node, a second input node, and a food event management system. The first input node is adapted to receive epidemiological information. The second input node is adapted to receive food distribution path information. The food event management system is coupled to the first input node and to the second input node. The food event management system is adapted to compare the epidemiological information and the food distribution path information to identify one or more possible correlations and to generate an event output related to the one or more possible correlations.

In another embodiment, a processor readable medium includes instructions to compare epidemiological information with food distribution path information to identify one or more possible correlations and instructions to generate a user interface to display the one or more possible correlations.

In another embodiment, a method includes receiving epidemiological information related to a plurality of reported illness incidents. The epidemiological information is compared to a plurality of food distribution paths to identify a correlation. An event output related to the correlation is generated.

In another embodiment, a system has a graphical user interface operable to display at least one reported illness incident. The graphical user interface is operable to display food distribution information related to at least one possible food distribution path related to the illness incident.

In another embodiment, an event detection system compares epidemiological information of an illness outbreak with one or more food distribution paths. Each food distribution path is associated with at least one food product. The event detection system detects a food contamination event based on a correlation between the epidemiological information and at least one of the one or more food distribution paths.

In another embodiment, a food event detection system has a remediation system and a user interface. The remediation system is adapted to provide remediation options responsive to an identified contamination event and to generate a list of tasks associated with each selected remediation option. The user interface is operable to display the remediation options and the list of tasks associated with each remediation option. The user interface is adapted to allow user interaction with the remediation options and associated tasks.

A food event management system provides a graphical user interface and related subsystems for detection, identification, management, and remediation of an evolving food contamination event. The food event management system can include systems for detecting a food event, for identifying a type or kind of food event, for tracing the source of the food event, for determining locations of contaminated products, and for tracking and managing subsequent actions to reduce the extent of illness outbreak and to mitigate exposure of contaminated product to the general population. The food event management system is adapted to utilize information from public databases, private databases, subscription databases, and various other information sources, including health networks (or even an early response system), which, in many instances, are already being maintained and updated in real time. By utilizing existing up-to-date systems, the food event management system can be used to quickly detect and identify evolving food events, to assess containment and remediation strategies, and to manage the evolving food event.

The food event management system is designed to be equally useful to public health officials, to public officials who are unfamiliar with food distribution issues, and to private industry producers, distributors, and manufacturers for managing their own food contamination incidents. In particular, the food event management system utilizes statistical algorithms and other analytical paradigms to analyze available information and to identify possible sources of contamination based on available information. Additionally, in some implementations, the food event management system can include additional functionality and processing power in terms of intelligence agents, artificial intelligence systems, neural-networks, learning systems, and the like in order to more rapidly and effectively manage a food event. Finally, the food event management system includes remediation options and strategies, as well as remediation tracking and tickler systems for monitoring aspects of a selected contamination remediation strategy. The terms “tickler” and “tickler system” refers to systems adapted to generate task-related reminders so that tasks are not overlooked or forgotten.

At the outset, it is useful to understand the terminology used herein. The term “remediation” generally refers to the cleanup, sterilization, or other methods used to remove or contain a contaminated area. In a general sense, remediation refers to the improvement of a contaminated site to prevent, minimize, or otherwise mitigate damage to human health. In addition, as used herein, the term “remediation” includes the development and application of a planned approach that monitors, removes, destroys, contains, or otherwise reduces the exposure of contaminants to receptors of concern (including, but not limited to, uncontaminated food products, food workers, consumers, and the like). The term “containment” refers to confinement of a biohazardous agent to prevent or limit its contact with people or the environment. The term containment includes containment using physical and/or biological barriers. The term containment may also include inactivation of a biohazardous agent using physical or chemical means.

In general, the food event management system utilizes available epidemiological information about an evolving food event to identify a contaminated food product, to identify a source and location of the contamination, and to provide containment and remediation strategies and options. As used herein, the phrase “epidemiological information” refers to the information about the incidence, distribution and control of food-borne disease within a population. Epidemiological information may include factors affecting the progress of the illness, such as who is affected, where are they both geographically and in relation to one another, when is the disease occurring, what is the cause, and why is it occurring. Available information may include answers to one or more of those factors, and the food event management system may assist in rendering decisions based on available information.

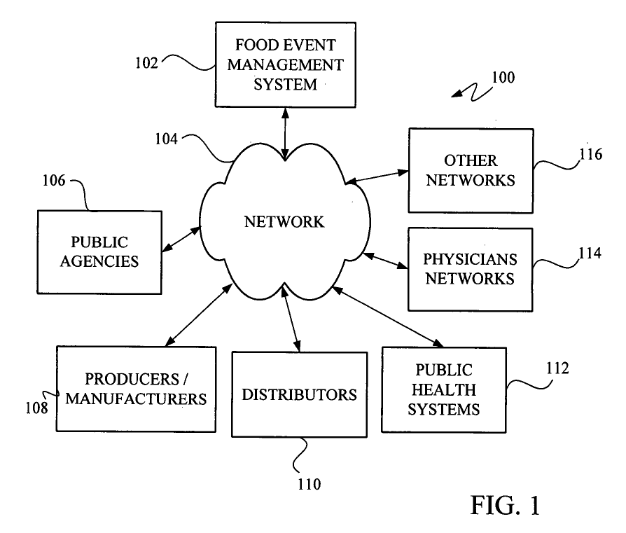

FIG. 1 is a block diagram of one embodiment of a food event system 100. The food event system 100 includes a food event management system 102 communicatively coupled via network 104 to one or more public agencies 106, producers/manufacturers 108, distributors 110, public health systems 112, physicians networks 114, and/or other networks 116. In general, the food event management system 102 is adapted to interact with various systems (such as databases, networks, lists, tables, and various other information sources) associated with public agencies 106, producers/manufacturers 108, distributors 110, public health systems 112, physicians networks 114, and other networks and systems 116 to facilitate identification, diagnosis, and management of an evolving food contamination event. A “food contamination event” refers to contamination of a food item by an undesirable agent (such as a microorganism or mold, chemical, toxin, radioactive material, etc.), which can cause illness.

The food event management system 102 monitors changes with respect to reported illnesses through the network 104 from various public health systems 112 and physicians networks 114. Upon detection of a food contamination event, or a possible food contamination event, the food event management system 102 may analyze automatically (programmatically) the distribution of reported illnesses relative to available product distribution data to triangulate to identify potential sources. Additionally, the food event management system 102 may be configured to generate an alarm based on a “strong” correlation between the distribution of reported illnesses and a food distribution path based on known food distribution patterns associated with one or more food products.

The network 104 may be a public or private network, including a plain old telephone service (POTS), a public switch network, local area network, wide area network (such as the Internet), cellular network, digital wireless network, or any other type of communication network. In a preferred embodiment, the food event management system 102 communicates with other systems over the network 104 via secure communication links, such as an encrypted link, a virtual private network link, or any other secure communication link. In an alternative embodiment, communication between the food event management system 102 and other systems may be communicatively coupled via wireless or wired communications, via a direct connection, or via local or wide area networks.

In general, it should be understood that the communication between the food event management system 102 and other systems may be periodic or on request, rather than continuous. In one embodiment, the food event management system 102 includes a software application or a plurality of cooperating software applications, which retrieve illness information from the physicians network 114 and public health systems 112, either automatically or upon request from a user. In an alternative embodiment, the food event management system 102 receives the illness information from a variety of sources, on start up, at scheduled intervals, based on receipt of a user command, or upon receipt of a signal indicative of an alarm condition.

Public agencies 106 may include the Center for Disease Control (CDC), various state, county and local health departments, public and private health information systems, and other systems for tracking emerging illness outbreaks. The producers 108 and distributors 110 of food products may provide information about product distribution and inventory locations, which can be used by the food event management system 102 to identify where contamination may have occurred in the food distribution path based on correlations between the food distribution information and illness outbreak locations. As used herein, the terms “producers” and “manufacturers” are used interchangeably to refer to those nodes in the food distribution path that are involved in the production of a food product. By contrast, the terms “distributors”, “retailers” and the like are used to refer to those who transport, market, or otherwise traffic or sell the already made product. For example, growers and ranchers are producers. A packaging or food processing company is also a producer. By contrast, wholesalers, retailers, grocery stores, trucking companies may all be considered distributors, since they are involved in the distribution of food products between producers and consumers.

The food event management system 102 may utilize closely held (confidential) distribution information received from producers/manufacturers 108 to trace a product (both forward and backward) in a food distribution path in order to locate inventory or packages of a contaminated product. The specific interaction between the food event management system 102 and the producers/manufacturers 108 and distributors 110 may vary depending on the specific implementation.

It should be understood that, in some instances, the various information sources may maintain confidential information, and that such information can be shared with the food event management system 102 under one or more confidentiality agreements. Moreover, such information may be provided for a one-time use, and discarded upon resolution of a food contamination event. For example, the information can be maintained in order to coordinate and monitor remediation efforts, recall efforts, and the like.

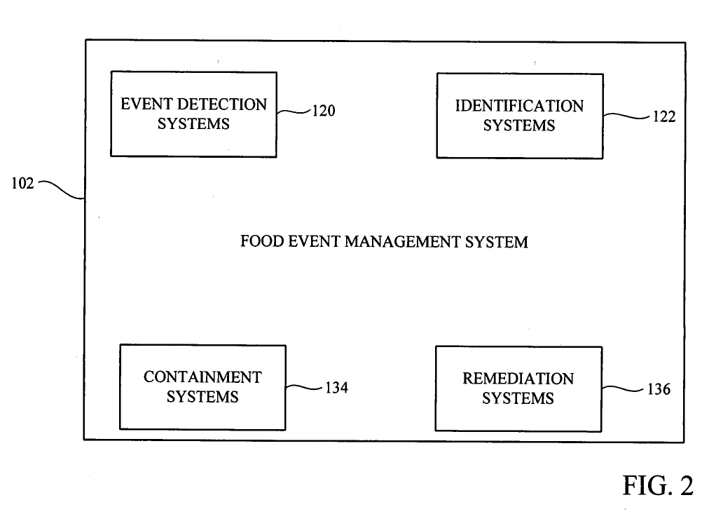

FIG. 2 illustrates a block diagram of an embodiment of the food event management system 102. The food event management system 102 includes a plurality of functions and/or systems, which may be loosely categorized into four types of systems: event detection systems 120, identification systems 122, containment systems 134, and remediation systems 136.

The event detection systems 120 can include a software application or programmable device adapted to detect a probable food contamination event based on geographic and time-based information related to illness outbreaks. The event detection systems 120 are adapted to report the detection information to a user (or to other systems 122, 134, and 136). In general, the event detection systems 120 may utilize symptoms, geographic distribution information, correlations between known food distribution paths and illness outbreak locations, and various other information to identify a possible food related illness outbreak. The event detection systems 120 utilize information derived from the one or more illness reporting systems to identify an emerging food contamination event. The event detection systems 120 may improve the time between the report of symptoms and the identification of a food-borne illness outbreak. The event detection systems 120 may include input systems, automated retrieval systems and various processors for acquiring and analyzing the health related information.

Once the event detection systems 120 detect a food borne illness based on the acquired information, the identification system 122 attempts to identify potential sources based on available epidemiological information, such as illness locations both geographically and relative to one another, such as the source of the illness and so on. The identification system 122 can be a software application or programmable device adapted to identify contaminated locations in a food distribution path based on available illness outbreak information. In some instances, the identification systems 122 may include algorithms for identifying a source of an outbreak.

Once the illness is identified, the containment systems 134 provide various strategies and options for mitigating the food borne illness, such as recalls, public service announcements and the like. The Containment systems 134 can include a software application or programmable device adapted to identify containment strategies for a particular contamination event and to provide options for user selections between such strategies in order to mitigate the effects of the food borne illness.

The remediation systems 136 provide context specific options for responding to the food-borne illness outbreak, including providing remediation options for cleanup of contaminated sites. The remediation systems 136 can include a software application or programmable device adapted to identify steps for implementing a selected containment strategy. The remediation systems 136 are adapted to provide a user interface to allow a user to assign responsibility for particular remediation steps to a person for oversight purposes. For example, the cleanup/remediation strategy will vary depending on the contaminant (e.g. type of mold or microorganism, chemical, toxin, radioactive material, etc.) and on the nature of the contamination (e.g. contamination source, and the like). The remediation systems 136 may also provide a user interface and associated subsystems for tracking remediation steps and providing reminders and alert messages to prompt a user to follow up on a particular remediation step until the step is completed.

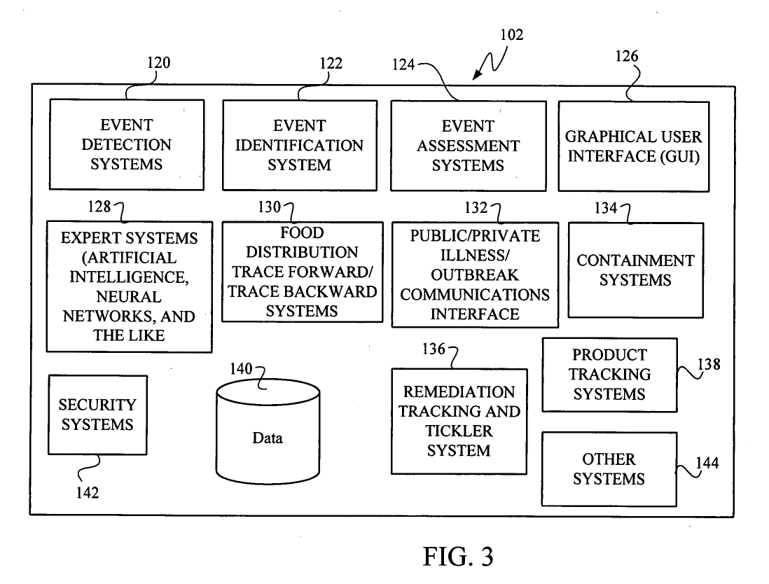

FIG. 3 illustrates an expanded block diagram of the food event management system 102. Various functions and capabilities of the food event management system 102 are depicted as discrete block elements for discussion purposes. It should be understood by workers skilled in the art that the specific functions or capabilities of the system may be implemented within a single application or may span several interrelated systems. Moreover, some functions may be shared by multiple components of the system.

As shown, the food event management system 102 includes event detection systems 120, event identification systems 122, event assessment systems 124, and a graphical user interface 126 through which a user may interact with the various systems. The food event management system 102 may also include expert systems 128 such as artificial intelligence, neural networks, intelligence agents and the like for assessing and identifying food contamination events. In some instances, the expert systems 128 may be utilized to identify a potential source of the contamination, the type of contamination and various other aspects of the management of a food contamination event. Though the expert systems 128 are depicted as a separate block, it should be understood that the expert systems 128 may be incorporated into one or more other components. For example, the event detection systems 120, event identification systems 122, and event assessment systems 124 can each include one or more of such expert systems 128.

The food event management system 102 can include food distribution trace forward/trace backward systems 130 adapted to receive food distribution information from distributors, manufacturers, producers, and the like, and to use the received information to trace food products within a food distribution path. For example, if a particular distributor provides information about distribution of a particular food product, that information may include information related to a distributor or producer upstream within the food distribution path (from which the particular distributor received the food product), as well as information related to one or more distributors or product resellers downstream within the food distribution path (to which the particular distributor delivered the food product). Additionally, the particular distributor may also provide information related to inventory that has not yet been delivered. Using this information, the trace forward/trace backward systems 130 can contact upstream and downstream businesses (or their associated systems) to trace the flow of the product through the distribution path.

The food event management system 102 includes a public/private illness/outbreak communications interface 132 for interacting with various public and private networks and systems, to retrieve information for display, and to apply expert analysis to data in order to detect events, identify food events, and assess ongoing outbreaks of illness.

The food event management system 102 also includes containment systems 134, which provide options and assessment of options for containing an outbreak of food borne illness. A remediation, tracking and tickler system 136 allows a user to assign specific tasks associated with remediation to particular individuals or agencies, and to track progress of remediation efforts to ensure that tasks are completed in a timely fashion. The product tracking system 138 traces the flow of food product items through the harvest, distribution and consumption stages in order to ascertain appropriate containment and remediation measures. For example, if after a period of time, the contaminated produce (according to a distribution tracking time schedule) would either be consumed or discarded due to spoilage, recall of the product would be a fruitless endeavor. In other words, a recall effort would be ineffective because the contaminated product would already be consumed or discarded.

The food event management system 102 also includes a data file 140 for maintaining information about users of system 102, various remote systems, and data associated with particular food items and contaminants, and, in some embodiments, food pathway information. It should be understood that data file 140 can include multiple data files, and the data may be stored in one location or on a plurality of servers. Additionally, data stored in the data file(s) 140 can include temporary food distribution data (for example, information provided under a “use and discard” agreement). In a second embodiment, information can be received, stored in a temporary cache of the data file 140, and processed directly from the cache. In this embodiment, data is written to a non-volatile data file 140 only if the information is determined to be relevant to a particular illness outbreak.

In a preferred embodiment, the food event management system 102 is adapted to receive electronic data from the distributors and other companies directly from their proprietary systems. Alternatively, the companies can log on to the system and enter the information as needed. In another embodiment, the system periodically transmits a current copy of its database information related to a particular company in either electronic or paper form, which the particular company can update and return.

In one embodiment, the food distribution pathway information for various food distribution paths is assembled from food distribution data stored in data file 140, which identifies and links various points in the food distribution system. Data file 140 could be populated with distribution information acquired by, for example, various government agencies (such as the Food and Drug Administration, and various state and local food monitoring agencies) and could be supplemented with vendor and product information for relevant food items acquired directly from registered companies. The vendor information can provide linkages between various points in the distribution pathway, as well as food item information that allows the linkages to be specific to each food product.

In an alternative embodiment, distribution information can be assembled via electronic requests to distributors local to an illness outbreak for current/recent distribution information related to particular products, which are possible carriers for sources of the identified illness. In this embodiment, customer lists can be acquired from the end point of the distribution pathway (the distributors) to the outlets for the food products (stores, food services, and the like), under various confidentiality agreements, for example. Additionally, the source from which the distributor receives his or her products can also be identified. In this manner, the product tracking systems 138 can trace forward and backward to dynamically assemble the food distribution pathway.

In each embodiment the food event management system 102 may utilize techniques to enable the distribution information to be reformatted and otherwise manipulated (“scrubbed”) so that information retrieved from different sources are structured in a like manner, and utilize comparable encoding systems for encoded information.

The neural networks or other artificial intelligence or expert systems 128 can be utilized to analyze information in an active incident detection mode. In one embodiment, this mode is used when a food contamination event is suspected, but not confirmed. In this case, the locations of suspected contaminations are entered into the system or derived from correlations between the food distribution paths and illness incidents. These locations can be used to triangulate to identify a probable contamination source within a food distribution pathway. This information enables epidemiological studies (and also possibly the government requests for food records) to be focused to those facilities that are linked to the suspected contamination.

Security systems 142 may optionally be provided to restrict access to particular elements or to all information associated with the food event management system 102. The security systems 142 may be a username/password log-in system, or a much more robust security system, including fingerprint, retinal scan, secure ID card, or other some other type of physical or digital security system.

Finally, the food event management system 102 may include other systems 144 for facilitating interaction between various components of the system and for facilitating management of the evolving food event. For example, in one embodiment, the other systems 144 may include a public notice system for communicating outbreak information to the press and to interested individuals via a broadcast warning system, a web site, and the like.

While the food event management system 102 has been illustrated as being connected to a network and/or to one or more external systems, it should be understood that the food event management system 102 can be implemented as stand-alone system within a single food product manufacturing company, for example. Each of the components may be stored on a single computer or distributed over a series of computers connected via a network.

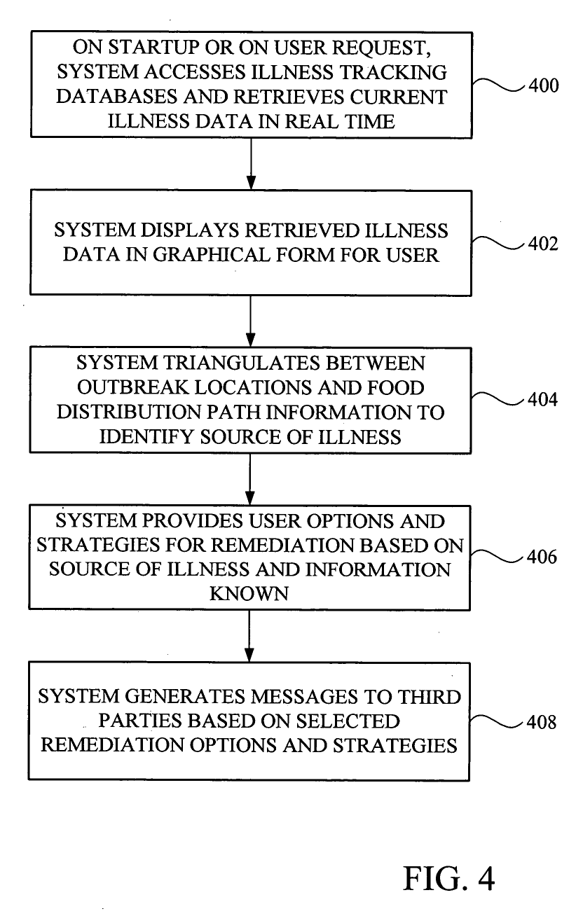

FIG. 4 is a flow diagram of one method for performing contamination event diagnosis and remediation. On startup or on receipt of a request by an authorized user, the system accesses illness tracking databases to retrieve reported illness data (block 400). The system displays the retrieved illness data in graphical form for a user (block 402). The graphical form of the information display may vary according to the specific implementation, and may include geographical maps, link and node trees, spreadsheets, lists, outlines, and the like. The system triangulates between outbreak locations and food distribution path information to identify a potential source of illness (block 404). Once the specific contaminant (e.g. salmonella, E coli, and the like) is known and the contamination means is identified (e.g. eggs, ground beef, and the like), distribution sources for the contamination means can be identified and the distribution path traced to locate a contamination point and all possible locations of contaminated product.

The system provides user options and strategies for remediation based on the illness source and known information (block 406). The remediation options available may depend on what is known about the illness outbreak. Once the source of the contamination is known, the system can identify potential food product carriers of the source, and utilize those identified food products to identify potential distributors. The system can compare the illness outbreak locations to source distribution profiles to trace the source to the contamination point and can generate a message to alert public health services (PHS) for possible outbreaks with certain conditions or issue a general PHS alert of an outbreak providing known information. Other intervention/remediation options and strategies are also available, including a national public health announcement, placing a hold on contaminated food products in stores and distribution centers, a public announcement of the outbreak, and a national recall of inventory of the contaminated food product.

Once the agent, food product, contamination point, contaminated inventory, and other related information are identified, intervention options include: placing holds on all of the identified food product, on all food products emanating from the contamination point, and/or issuing a national recall of all food product, of food product emanating from the point of contamination, or of the specific lots of food products that are contaminated. Additionally, remediation steps may include sterilization of locations that contained contaminated food products. It should be understood that the notification/alert options may be performed manually by the public health officials involved. The system generates messages to third parties based on selected remediation options and strategies (block 408). These third parties may include newspapers and other news outlets, distributors, producers, and the like.

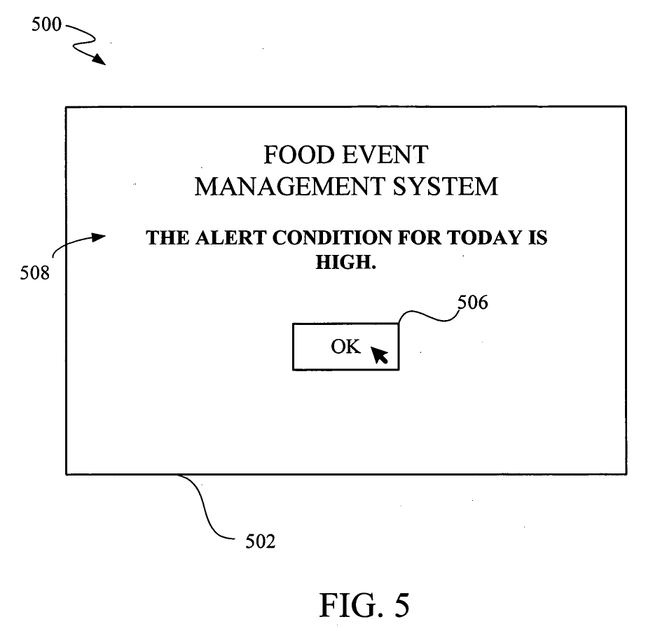

FIG. 5 illustrates one embodiment of an initial screen of a graphical user interface 500 generated by an event management system 102. The graphical user interface (GUI) 500 includes a window 502 containing an okay button 506 for accessing the food event management system. Depending on the implementation, the initial screen may include login and password prompts (or other authorization means) for authorizing access to the system. In the embodiment shown, access is granted based on a digital certificate.

The GUI 500 also provides an initial indicator or alert message 508 indicating the most extreme indicated condition for the particular day. In this instance, the alert message 508 indicates the health alert condition to be “high”. In general, the alert conditions of the food event management systems may be divided into risk groupings, such as: low risk, medium risk, and high risk. A low risk situation corresponds to reported illnesses having symptoms that are not related to extremely harmful sequelae or corresponding to known contamination points having limited range (such an individual's home). Additionally, a low risk condition may be indicated where there are early onset indications of potential illness outbreak, but where the source or cause of illness is not yet indicated. Consequently, the seriousness of the particular outbreak has not been ascertained. A medium risk condition may be indicated where a small number of individuals have turned up with symptoms relating to a particular illness, which may be extremely severe and/or highly transmittable, but which has not been definitively diagnosed. Thus, the known information indicates a potentially dangerous outbreak. A high alert condition may correspond either to a significant outbreak in terms of numbers or to an identified outbreak of illness that is highly contagious or that involves transmittable agents, as indicated by diagnosis of various individuals showing symptoms. Often the high alert includes a definitive diagnosis of the illness source, or at least a determination with a high probability of accuracy.

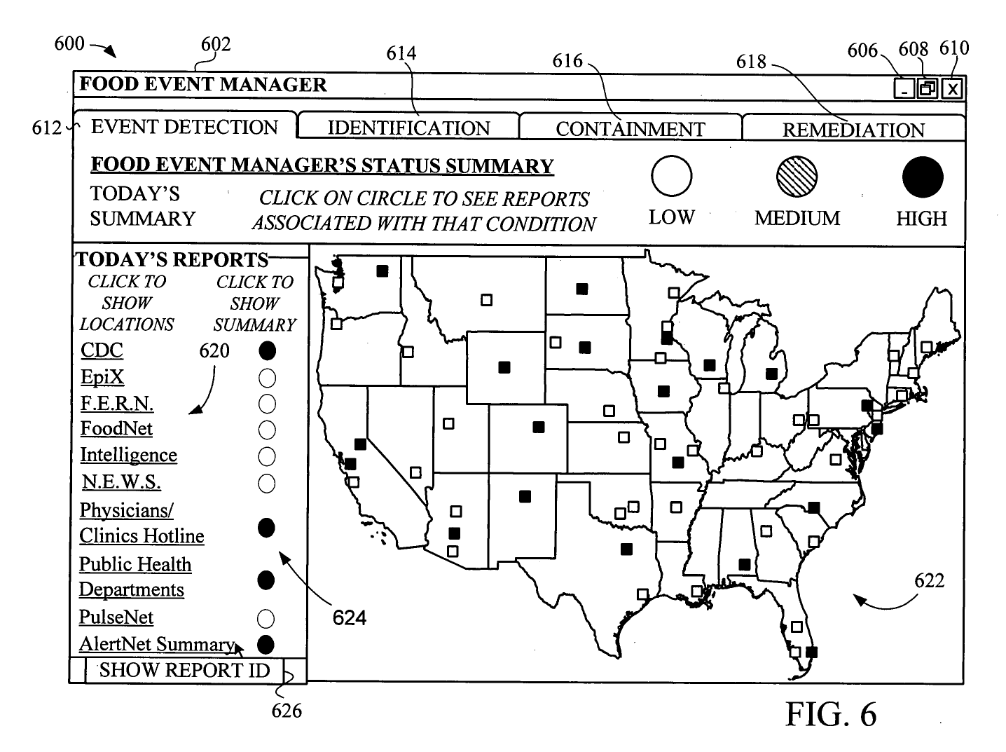

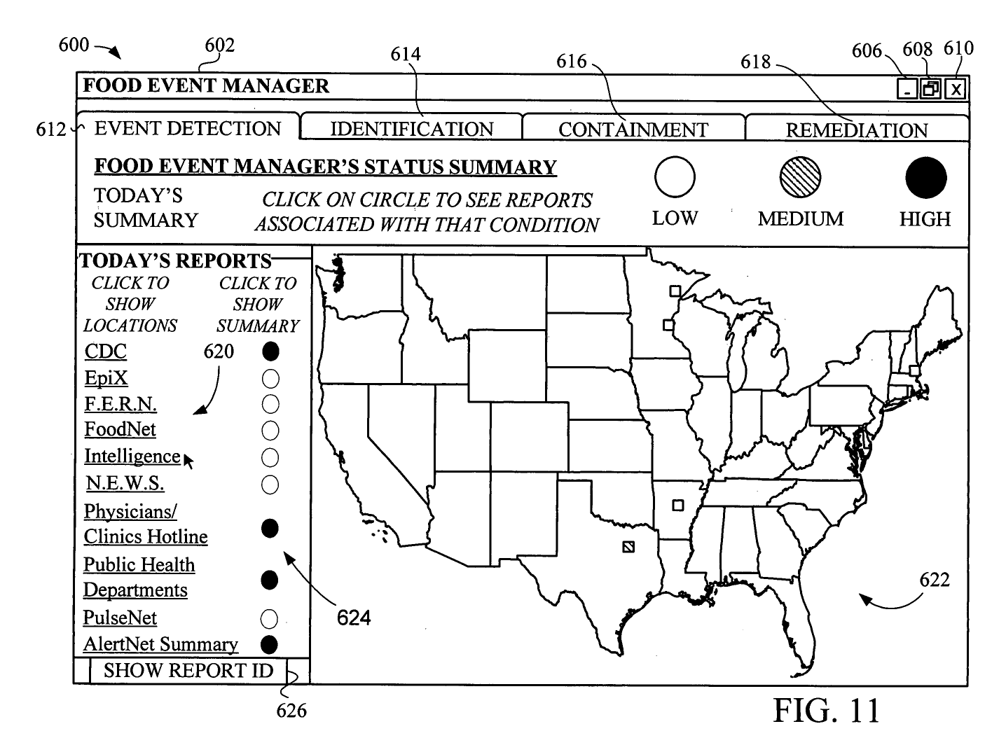

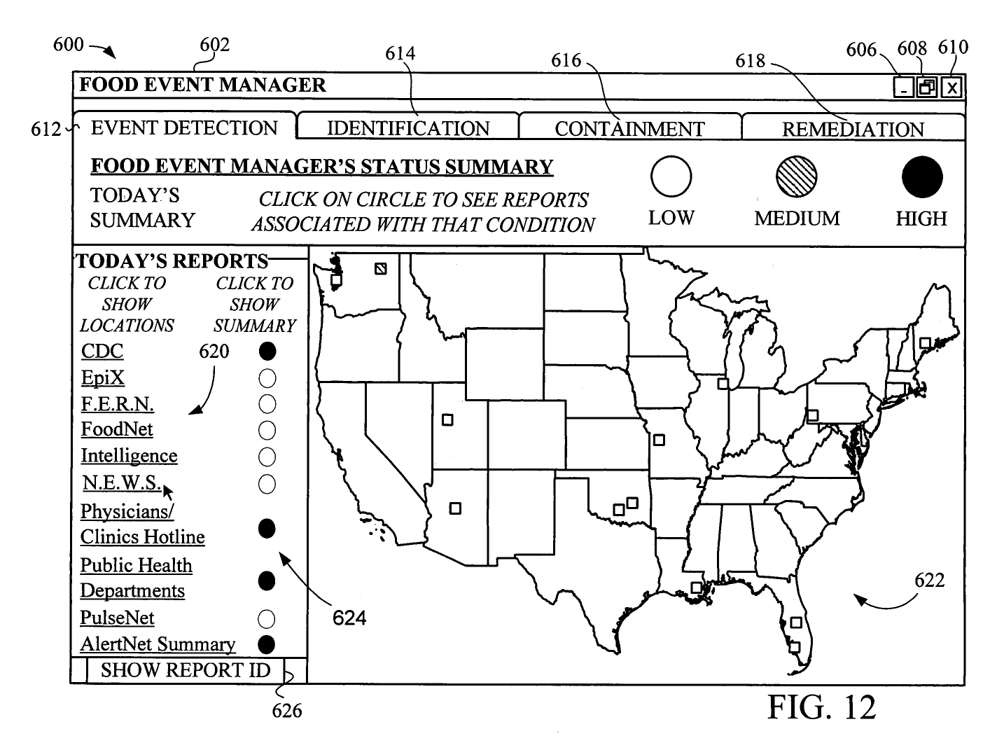

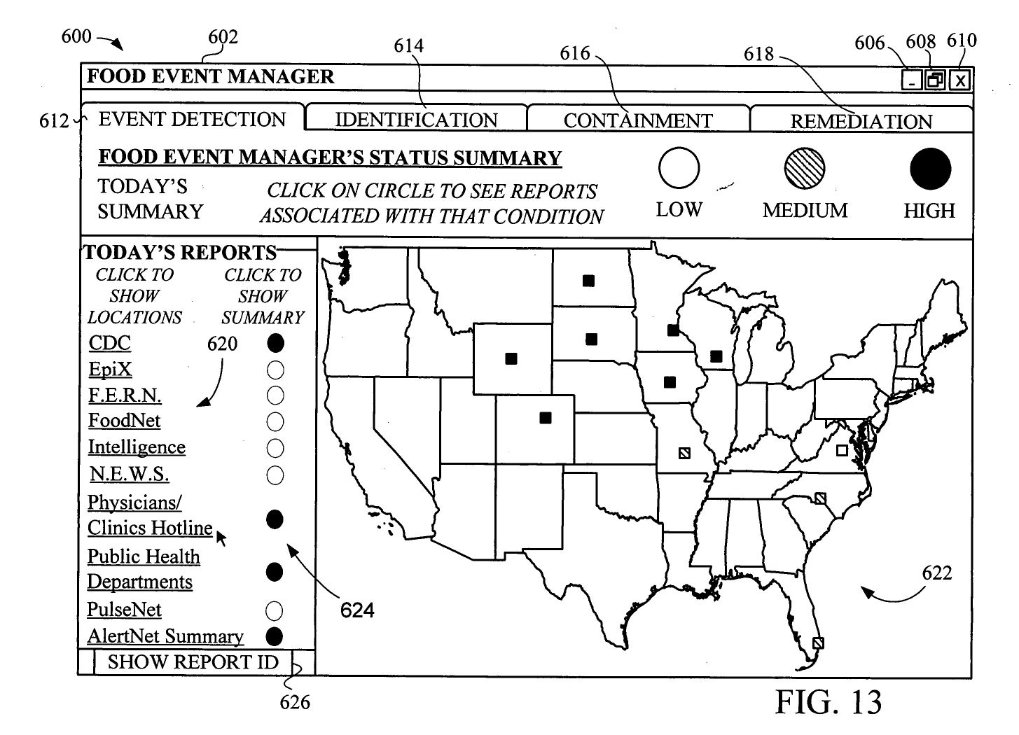

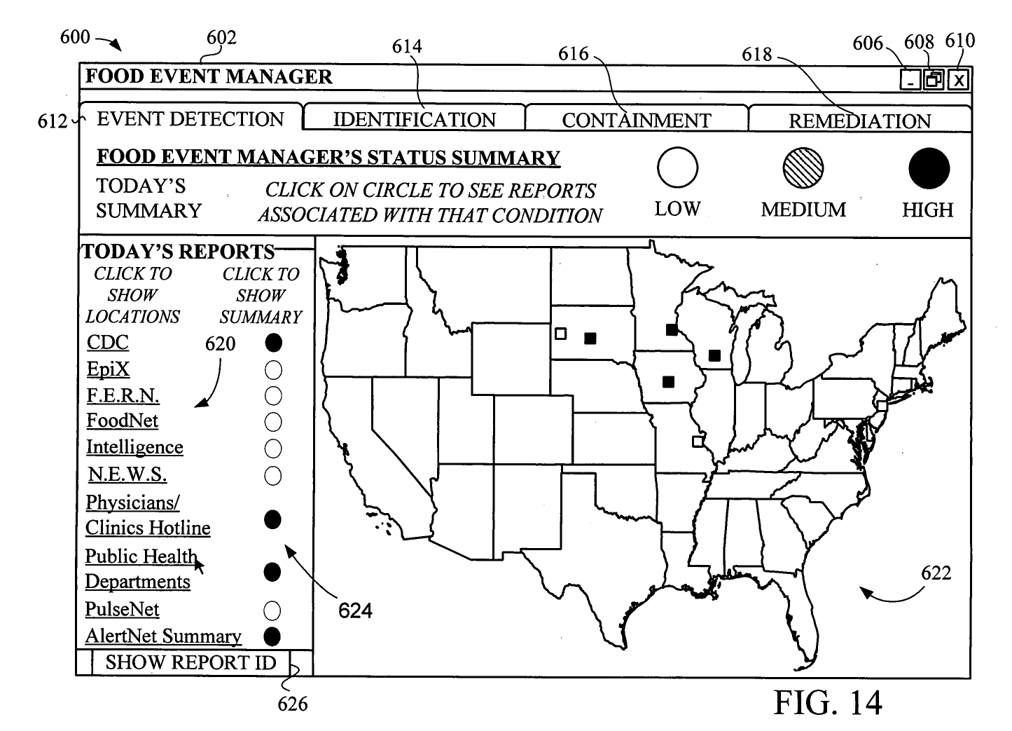

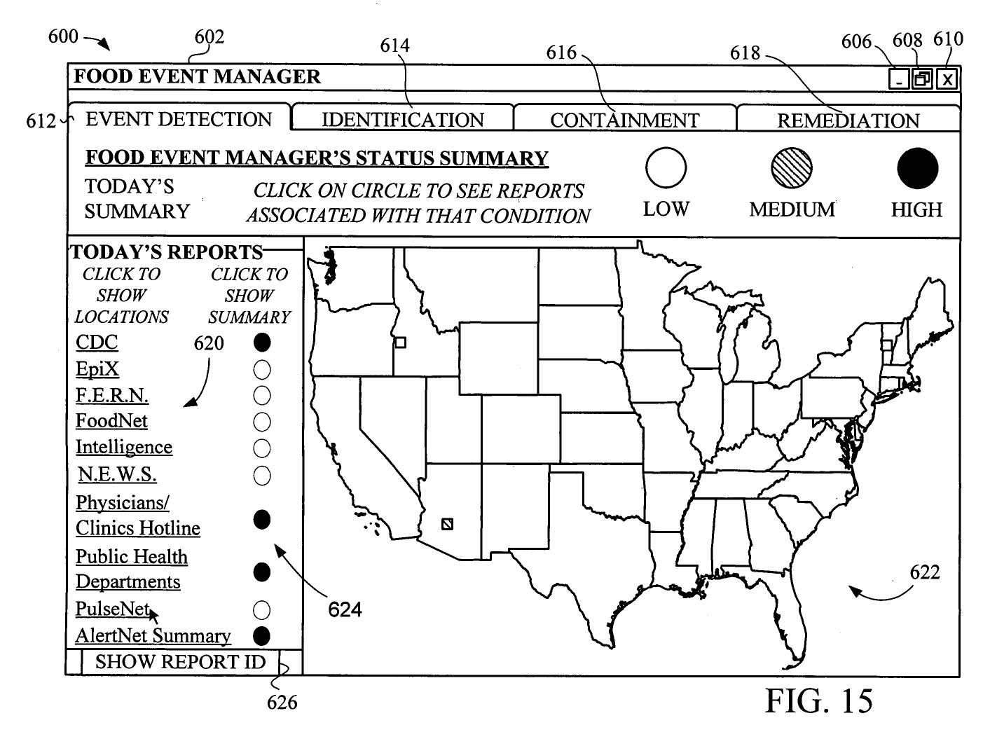

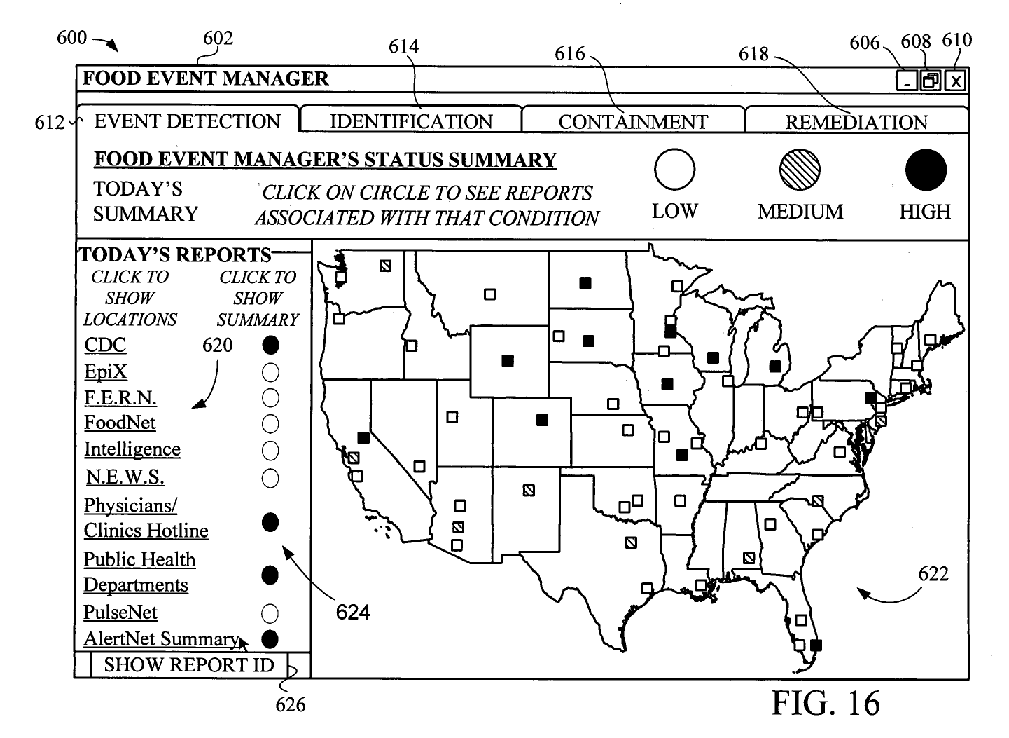

FIGS. 6-25 illustrate various views of the graphical user interface illustrating various techniques for displaying information to a user, and illustrating results from analysis of the information by the food event management system. It should be understood from the outset that the data utilized to illustrate the various screens is not based on any real food-borne illness outbreak. In general, the figures are provided for illustration purposes only.

FIGS. 6-17 illustrate an event detection view of the graphical user interface (GUI) 600 according to one embodiment of a food event management system 102. The GUI 600 provides a window 602 within which information is displayed. The window 602 may be organized like a standard window under the Microsoft Windows operating system, including a title bar 604, which contains the title of the application as well as a minimize button 606, a shrink/maximize button 608, and a close button 610. The window 602 also includes an event detection tab 612, an identification tab 614, a containment tab 616, and a remediation tab 618 (each of which are discussed in detail below with respect to FIGS. 6-17, 18-19, 20-23, and 24-25, respectively.

In FIGS. 6-17, the event detection tab 612 is selected. The event detection tab 612 contains a list of databases 620, which the user can select to display the reported illnesses corresponding to the specific database on the map 622. By default, the map 622 is displayed with all reported illness marked directly on the map 622, and with the alert condition indicated based on the shading of the mark. It should be understood by a worker skilled in the art that more than three levels may be used to indicate the health conditions, and that various techniques may be utilized to display the information on the map, including different colors, different shading, different shapes, and so on. Moreover, though the map 622 illustrates only the continental United States, any map may be used, including a regional map, a map of the entire United States and its territories, or even a map of the world or of various other countries or continents. If the food event management system 102 is implemented for use by a single company, the map can illustrate only those regions that are relevant to the particular company. The map of the United States is provided for ease of reference.

In one embodiment, each state or similar subdivision of the area on the map is clickable, meaning that if a user selects the state or subdivision, a magnified view of that area including additional details relating to the reported illnesses may be displayed. For example, clicking on the map of South Dakota would cause the GUI 600 to display an enlarged view of the state, including city demarcations, which would show that the two reported illnesses in South Dakota were identified in Pierre and in Rapid City. Moreover, the enlarged view could provide an indication of the number of reported illnesses in each location, contact information for the reporting physicians or local health officials, and so on.

Within the list of databases 620, an indicator 624 is provided next to each database, showing the worst alert condition reported by that database. It should be understood by a worker skilled in the art that each reporting database may have different reasoning for making severity determinations. Consequently, an outbreak condition may be indicated by both the CDC and the FERN databases, but in some locations, the indicated severity may be different. The GUI 600 simply chooses the indication based on the worst alert indication.

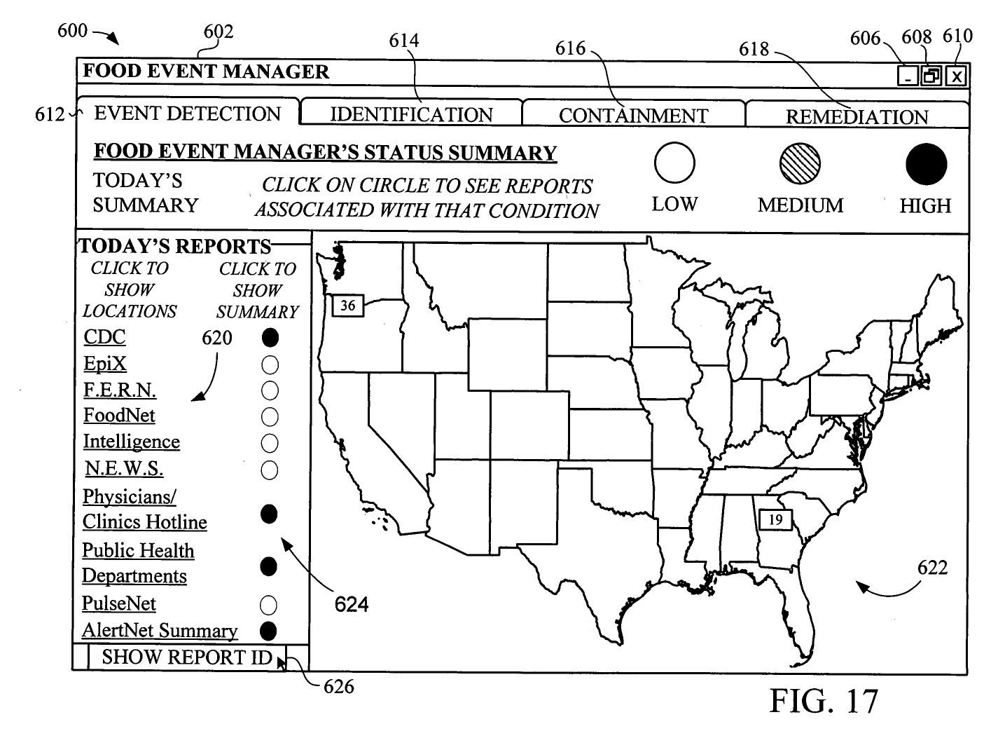

Finally, a report ID button 626 is provided, which provides a report ID number directly onto the indicated outbreak marker on the map 622 (as shown in FIG. 17).

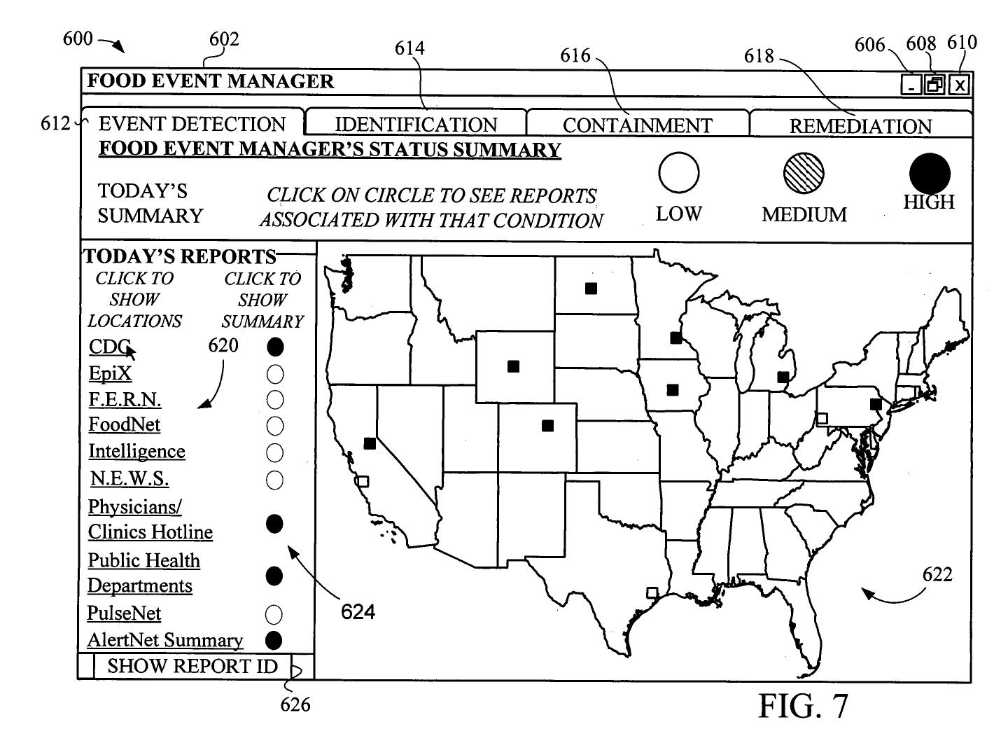

In FIG. 7, the CDC database is selected as indicated by the pointer. The GUI 600 displays the CDC illness outbreak information on the corresponding geographic location on the map 622.

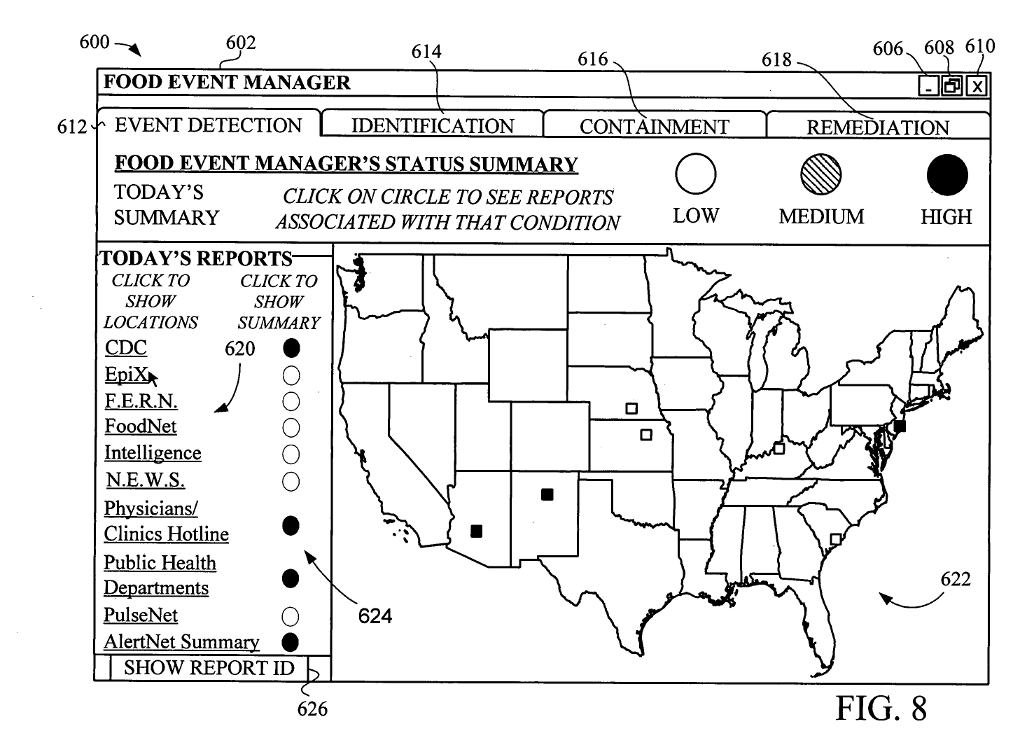

In FIG. 8, the EpiX database is selected. The GUI 600 displays the EpiX illness outbreak information on the corresponding geographic location on the map 622.

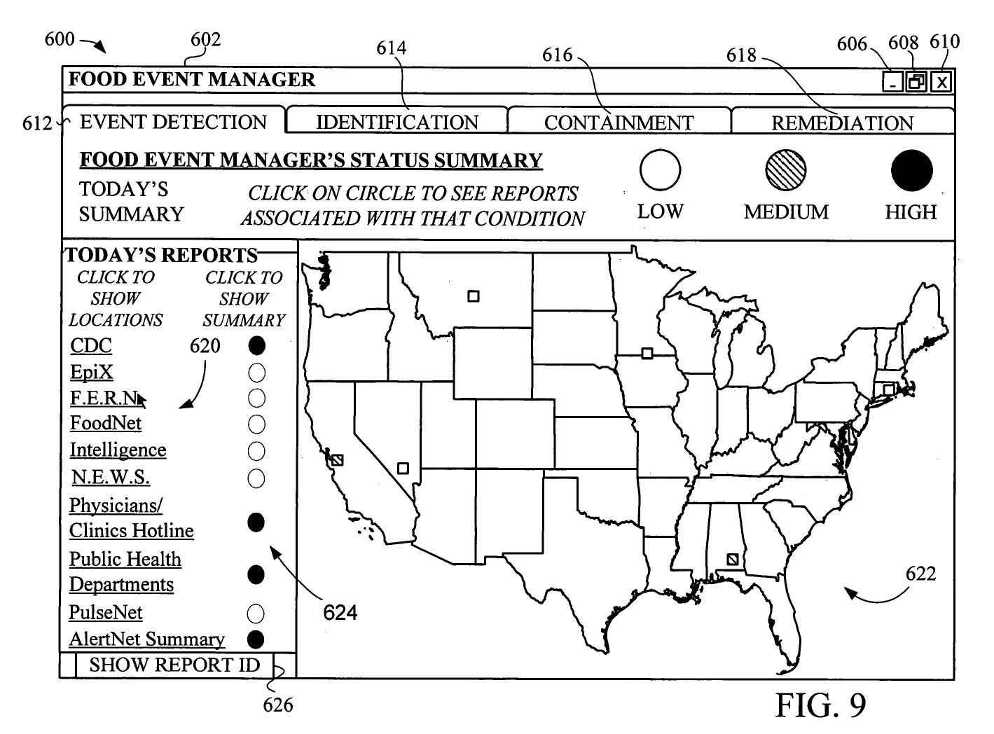

Similarly, FIGS. 9-16 illustrate the various illness outbreak information for the databases in the list.

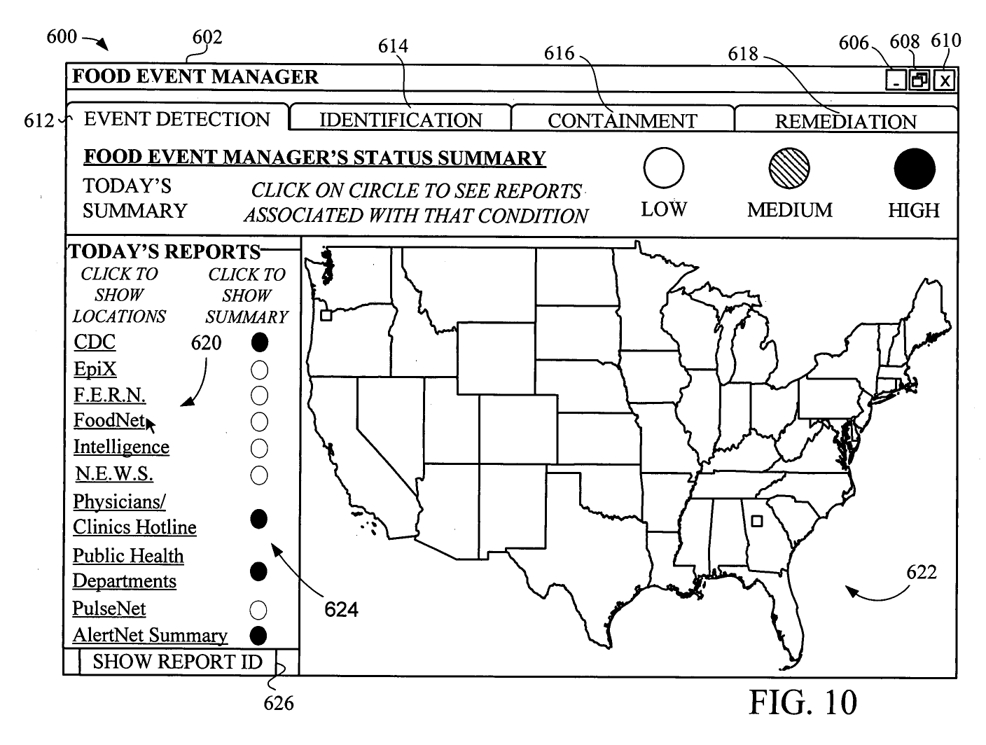

FIG. 17 illustrates the illness outbreak information corresponding to the FoodNet database (see FIG. 10) when the user selects the show report ID button 626. In this instance, the two illness reports related to report ID numbers 36 and 19. The report ID number refers to a serial number or other identifier by which the specific information associated with a reported illness may be retrieved and/or referred to. Alternatively, instead of a report ID, the GUI 600 may provide information associated with the number of reported illnesses, or other useful information.

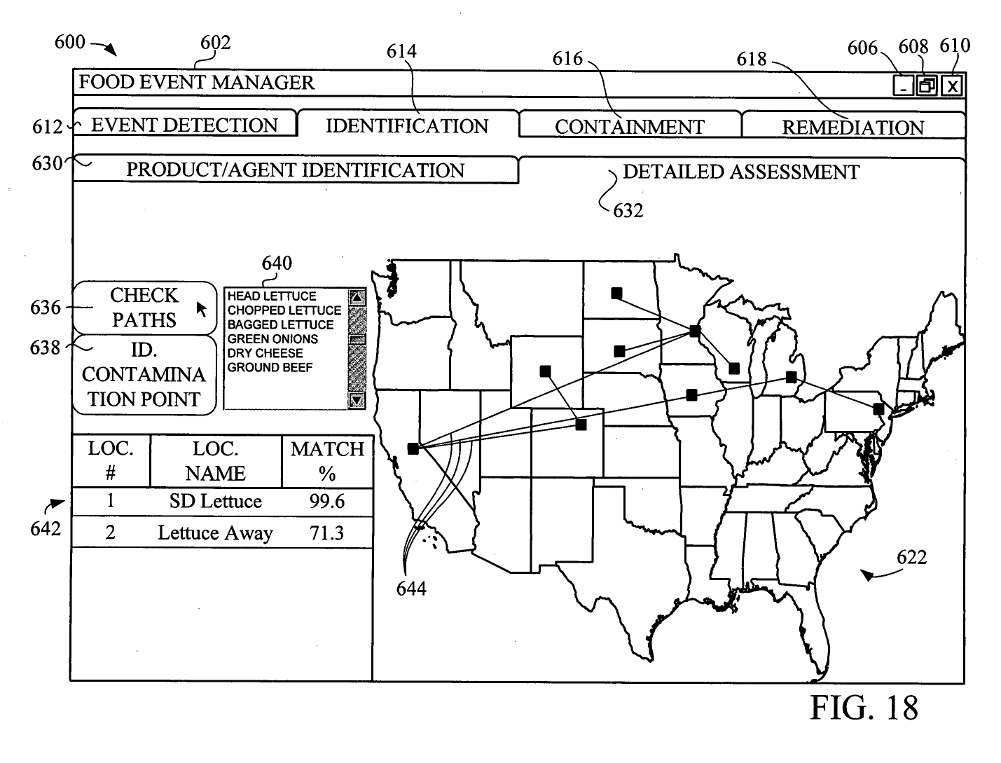

FIG. 18 illustrates the GUI 600 with the detailed assessment tab 632 selected. The detailed assessment tab 632 provides details relating to the identified illness. Specifically, a user can test distribution paths of various food products against the reported illnesses by clicking the check paths button 636. The system attempts to match known distribution paths against the reported illnesses. As shown, the system has drawn lines 644 indicating in location/match window 642 that the distribution path from location #1 (SD Lettuce) provides a 99.6% path distribution match with the reported illness locations. The distribution paths are indicated by lines 644 connecting the illness markers on the map 622. Selection window 640 includes a list of types of lettuce products distributed by SD lettuce. A user can select one or more of the types of lettuce products, and the GUI 600 adjusts the plot points and associated lines 644 on the map to reflect the distribution of only the selected types of lettuce products. At this point, a user could select the ID contamination point button 638 to identify the likely contamination point within the distribution path, based on the illness outbreak locations. For example, all illnesses may correspond to delivery locations for a particular distributor, and if no other illness outbreaks are indicated with respect to other distributors of the product, then it is likely that the distributor is the contamination point.

Generally, the detailed assessment system operates particularly well when the type of product that is contaminated has been identified. The distributors for this type of product can then be identified and so on. With fresh head lettuce, for example, there are only a handful of large scale head lettuce producers in the United States, so the distribution paths can be traced with greater ease. Of course, the system might struggle to identify a local farmer, for example, but contaminated produce from a local farmer would affect fewer people in a smaller area as compared with a large, national producer.

In one embodiment, the system automatically scans the list of products 640 and one-by-one attempts to match the known distribution paths to the illness outbreak. In an alternative embodiment, a user may select a product from the list and manually compare the paths to the illness outbreaks to try to identify a potential source. In a third embodiment, the product must be known, and generating distribution path requires the system to contact each of the known distributors of the product in areas adjacent to the illness outbreak to retrieve delivery locations, which are then added to the map 622. In this embodiment, the identified delivery locations upstream and downstream from the known distributors are then contacted, in order to identify all locations for the contaminated product. Those locations are then added to the map, and the match percentage can be updated to reflect the new information.

In general, it should be understood that a correlation or correspondence between illness outbreak locations and product distribution locations is likely to be imperfect, meaning that such a correlation is likely to be less than one hundred percent. Moreover, there are delays between distribution, sale, consumption and illness onset, which vary from product to product and from illness to illness. These variations make identification difficult. However, there are many known statistical techniques for analyzing sets of random variables relative to one another to determine probabilities, such as whether such sets may be correlated. Depending on the specific implementation, one or more statistical techniques may be employed. Moreover, different statistical techniques may be used to analyze available data, depending on the content of such data, depending on user inputs, and so on.

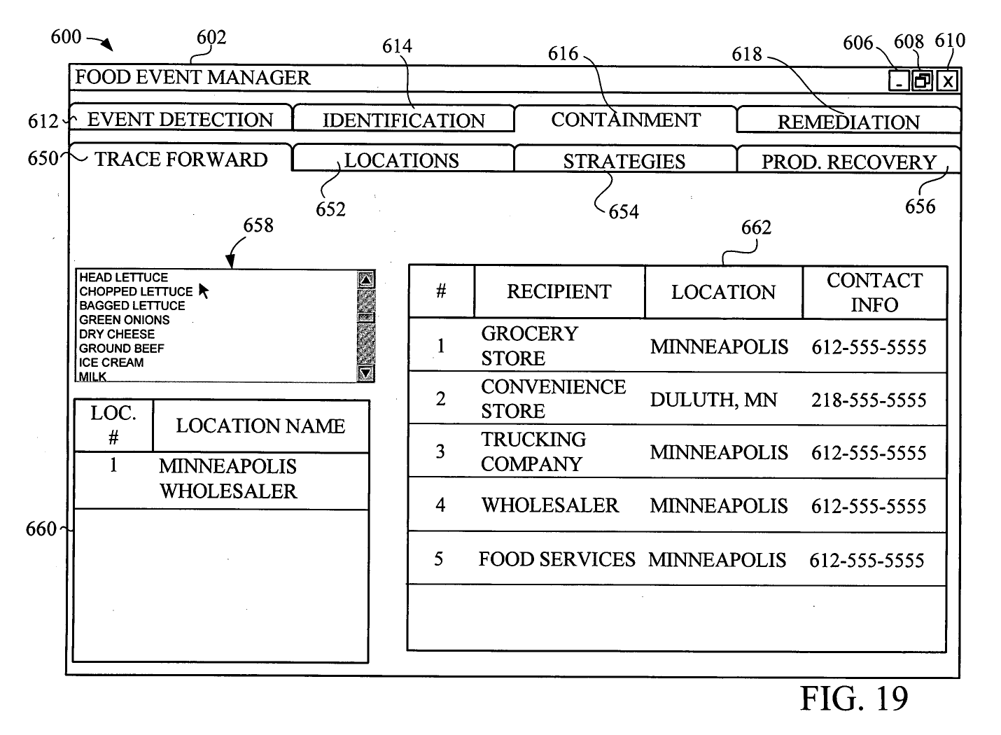

FIG. 19 illustrates a containment tab 616 of the GUI 600. Unlike the previous figures where the location information was used to match a distribution path to the illness outbreak, in the embodiment shown the location information is utilized to provide contact information for the public health official to contact and notify the upstream and downstream locations of a potential contamination event, or of the actions required of the various companies to remediate the contamination.

Here, a Minneapolis wholesaler is identified as a possible contamination source for the head lettuce contamination. A product window 658 displays the various products. A contamination source window 660 displays the most significant known common contamination point. Downstream recipients of the contaminated product are shown in the recipient window 662.

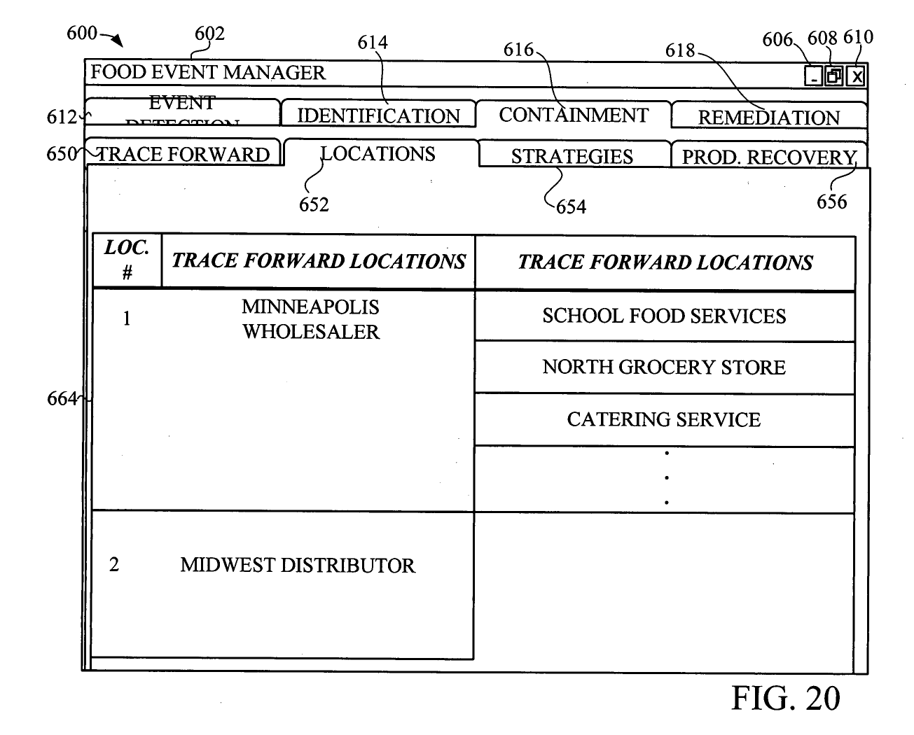

Selecting the location tab 652 within the GUI 600 provides more detailed information about a highest-level known common contamination source and the downstream distribution information in the trace forward locations window 664 as shown in FIG. 20. The contaminant locations indicate common potential contamination points, and their downstream distribution locations for the potentially contaminated lot(s) of food product. In general, this list would be assembled dynamically by the system interacting with the distributor's database to assemble the information on the fly and to build a delivery profile for the contaminated product. As upstream contamination sources are identified within the food distribution path, the Minneapolis wholesaler and Midwest distributor may be moved to the trace forward locations list and so on. In general, the trace forward and trace back system assembles the food distribution path dynamically using the distributor's information. Thus, the distribution path will be as accurate and up-to-date as possible, so as to minimize the disruption to the food industry caused by the particular intervention/remediation strategy chosen.

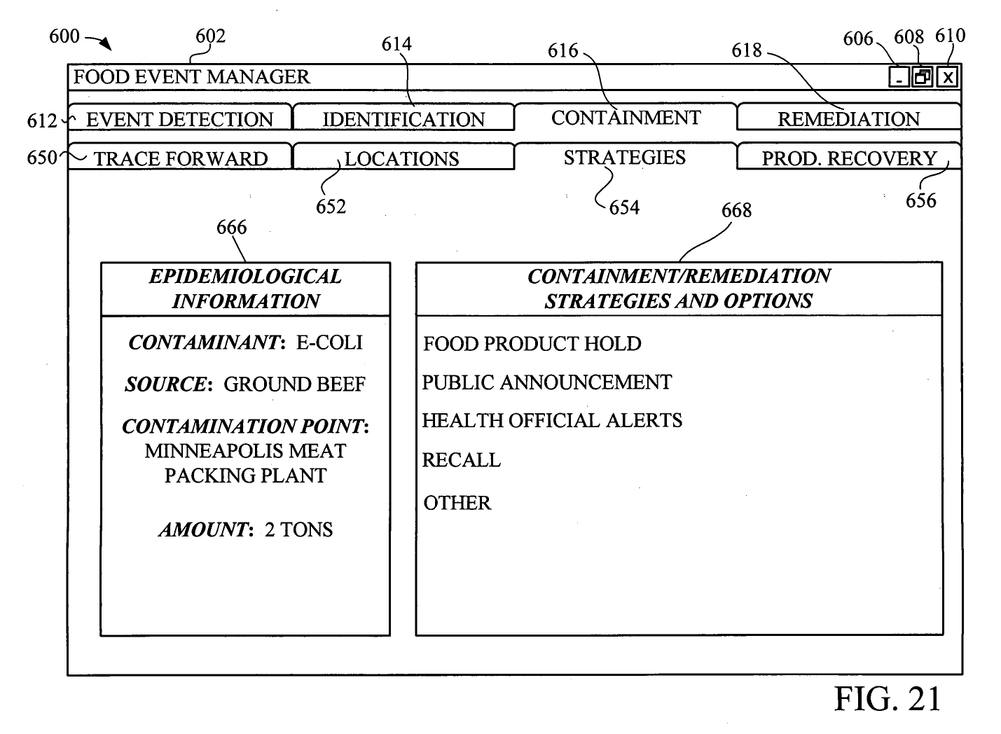

FIG. 21 illustrates an embodiment of the GUI 600 with the strategies tab 654 selected. The strategies tab corresponds to remediation strategies associated with a particular event. In general, the system may include a database containing epidemiological information associated with specific food-borne agents and associated remediation techniques for preventing later outbreaks.

For example, salmonella contamination may require sterilization of specific equipment and so on. Anthrax or other types of contamination may require specific remediation steps that are not necessarily commonly known. The database may contain such information. Consequently, strategies and remediation steps can be based upon the necessities of the particular agent.

Within the strategies tab 654, an Epidemiological information window 666 shows the known information about the particular outbreak. Associated or available strategies for remediating and managing an intervention are shown in the strategies window 668 within the GUI 600.

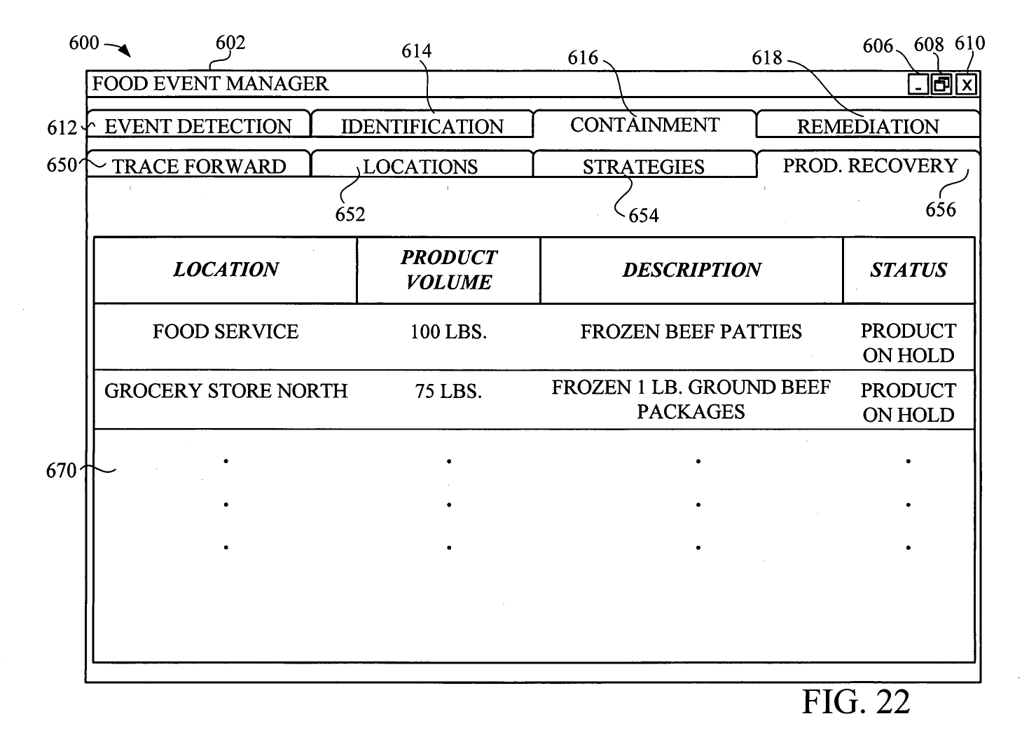

The product recovery tab 656 shown in FIG. 22 provides information related to the recovery of contaminated product in a product recovery window 670. In this embodiment, status information is provided relating to the recovery of contaminated products from various locations. However, this window may alternatively provide a statistical analysis of the volume of contaminated product that may still be recoverable, based upon a food distribution profile corresponding to the particular item. The process for assembling a food distribution profile and the contents of such profiles are described in U.S. patent application Ser. No. 10/681,581 filed Oct. 8, 2003, which is incorporated herein by reference in its entirety.

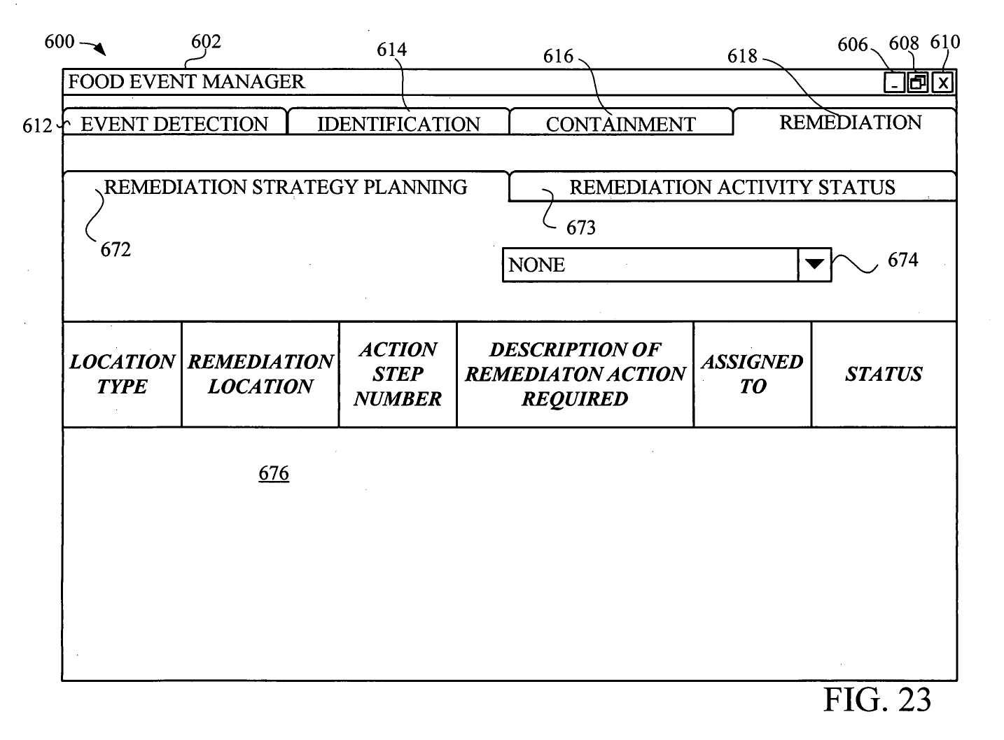

FIG. 23 illustrates the GUI 600 with the remediation tab 618 selected. Within the remediation tab 618, the system offers a remediation strategy planning tab 672 and a remediation activity status tab 673.

Within the planning tab 672, the user enters tracking information in a planning window 676. Typically, the user entering such information would be overseeing the remediation effort. Here, the manager or other user inserts the location type (such as a manufacturer, distributor, and so on), which may be indicated by a code (e.g. “D” equals “Distributor”, “M” equals “Manufacturer”, and so on). The remediation location, action step correlating to the specific illness source, description of the action, who is assigned responsibility for the action, and the status are all indicated here. The assignment of responsibility is typically associated with a public health official assigned to oversee the remediation steps for that facility.

For example, if an ice cream plant is contaminated with salmonella, the remediation location might be the ice cream manufacturing plant. The action step number might be “#1”, which corresponds to identifying the contamination source in the plant (or outside the plant). Subsequent action steps may include recalling all contaminated products, sterilizing the contaminated vats and conduits, and so on. The oversight responsibilities would be assigned to a public health official, who would update the status of the remediation efforts in the system as the remediation progressed.

The pulldown menu 674 provides a list of current food contamination events being managed by the system. In this instance, there are no selected events, so the remediation information is not filled in.

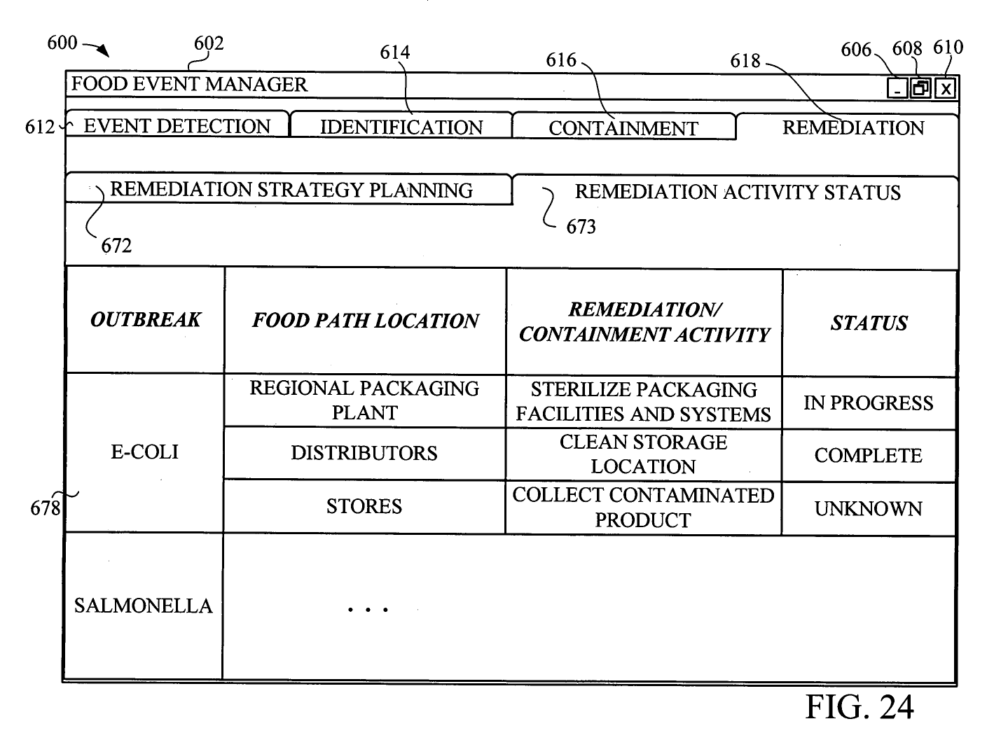

FIG. 24 illustrates the remediation activity status for one or more illness outbreaks. As shown, the status window 678 provides the epidemiological information about the outbreak, followed by contamination locations, current/pending remediation activities and their status.

The food event management system 102 is designed to enable quick, efficient identification and containment of a food contamination event. Moreover, the system is designed to interact with existing computing systems of distributors and manufacturers to minimize the overhead and expense to industry, thereby increasing the likelihood that companies will cooperate by responding to information requests. When a food contamination incident has evolved to the stage at which a public health agency is able to identify suspected product(s), the system provides contact information for all locations that potentially contain the contaminated food product(s). Optionally, the system can then automatically contact all these locations to inform them of any required action, such as containment, hold or recall.

The system may also be able to assist a public health official or other user to identify the distributor(s) and product(s) involved in a contamination incident by comparing the geographic location of illness reports with the known pattern of the food distribution network to triangulate on the specific distributor(s) involved in the incident.

Additionally, the system may be operated in a food trace mode as described above with respect to the figures. The food trace mode is used when a contamination of the food supply is confirmed and a containment or recall action is to be taken. In this case it is important to identify the actual locations where the contaminated product is located, so that the recall/containment effort can be focused on the actual sites affected. This focus is particularly significant if the contaminant has possible residual effects (for example, Anthrax which has spores that can continue to contaminate a site and food products in contact with that site) so that decontamination of the affected sites is required. The system provides tools for tracking remediation efforts with respect to such decontamination requirements.

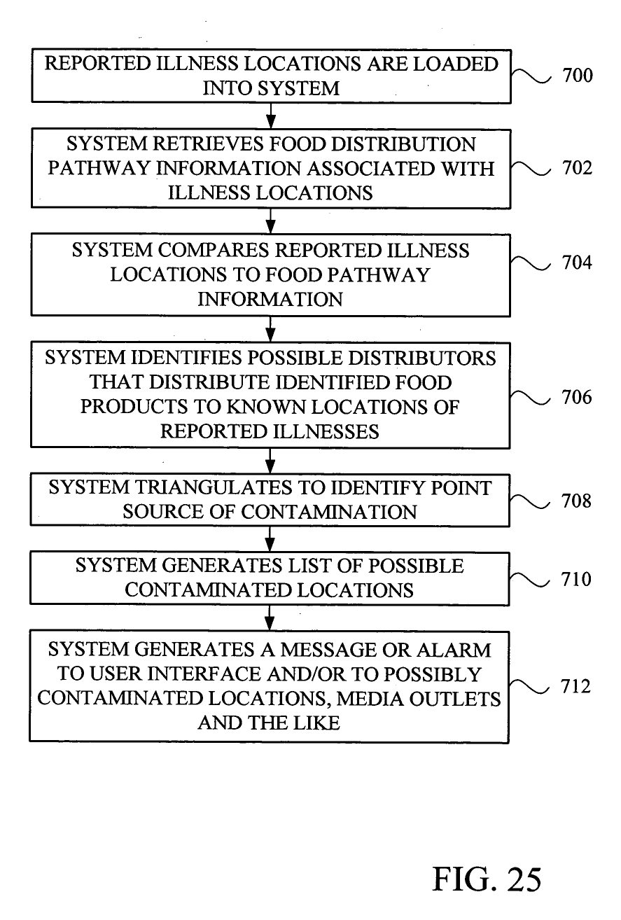

FIG. 25 is a flow diagram of a process for identifying distribution pathway locations that may have been contaminated by a food product using a food event management system. Reported illness locations are loaded into the system (block 700). As previously discussed, these locations may be manually input by a user (for example, with a computer keyboard, touch screen, mouse, etc.). In a preferred embodiment, the illness/outbreak locations are programmatically retrieved from existing surveillance system data on startup of the food event management system.

The food event management system retrieves food distribution pathway information associated with the illness locations (block 702). In one embodiment, food distributor list is maintained in a data file, and recent product distribution information (such as the type of products that the distributor carries and sells) may also be maintained. This information can then be retrieved by the system. In one embodiment, only distribution information associated with distributors that carry particular products, which could be the source for the food-borne illness, are retrieved.

The food event management system compares reported illness locations to food pathway information (block 704), and identifies possible distributors that may have distributed the contaminated product to known locations of reported illnesses (block 706).

The system then triangulates to identify the point or source of contamination within the food distribution pathway (block 708). The system generates a list of all possible contaminated locations in the food distribution pathway (block 710). The system generates a message or alarm to all contaminated locations, to media outlets, to public health officials and so on (block 712).

In general, when a contamination of the food supply is confirmed and a containment or recall action is required, the food event management system is initiated by logging into the system. In one embodiment, the system automatically loads location and timing information related to reported illnesses from various information sources. Alternatively, a user can manually enter such data. The food event management system uses the data to trace back to identify all distributors who shipped the implicated food product to all the locations of reported contamination. The system then requests from the implicated locations the detailed information of day-to-day shipments. This information is used to generate a list of all outlets that received the contaminated product. Additionally, if desired, an agency or company can notify the food event management system of a recall/containment action that is required, and the system can forward this notification to all locations that potentially contain contaminated product.

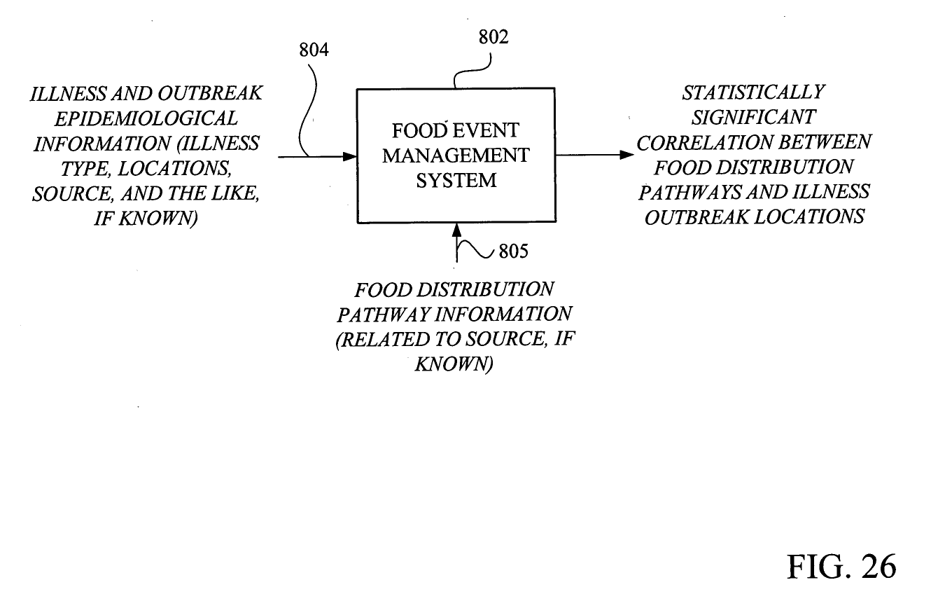

FIG. 26 is a block diagram of system 800 for analyzing food-borne illness information. The system 800 includes a food event management system 802. The food event management system 802 has a food pathway input 804 for receiving information maintained and provided by manufacturers, distributors, resellers, and the like and relating to the food product distribution (as indicated by block 806). The food event management system 802 also includes an illness/outbreak information input 808 for receiving illness/outbreak information from a user input device, data files, or a plurality of data sources (block 810). The food event management system 802 includes a statistical food distribution data 812, which includes profile information for food items from production to consumption. The statistical food distribution data 812 may be used to estimate the effectiveness of various remediation efforts. Generally, this information may be acquired over time based on information derived from food illness outbreaks, or may be assembled specifically for each type of food product independent of any food incidents.

The food event management system 802 also includes agent data 814, which may be entered by a user input device or retrieved from a data file (block 816). Generally, an analysis engine 818 receives food pathway information from the food pathway input 804, illness outbreak information from the illness/outbreak information input 808, statistical distribution data 812, and agent data 814. The analysis engine 818 compares the pathway and illness data to find correlations. Additionally, the analysis engine 818 may impose limits based on illness symptoms, agent information and statistical data to identify a contamination point and other potentially contaminated distribution locations. Finally, the analysis engine 818 generates output information to an output device 820, which may be a computer screen, a network port, a transceiver, or any other device capable of displaying or otherwise delivering information to a user or other intelligent system for use in decision-making.

It should be understood by a worker skilled in the art that the analysis engine 818 may represent one or more micro-processors running various software algorithms for processing the information. Alternatively, the analysis engine 818 may be one or more dedicated processors for processing data in a predefined manner. In another embodiment, the analysis engine 818 is one or more intelligence agents, neural networks, or other expert systems for analyzing available data.

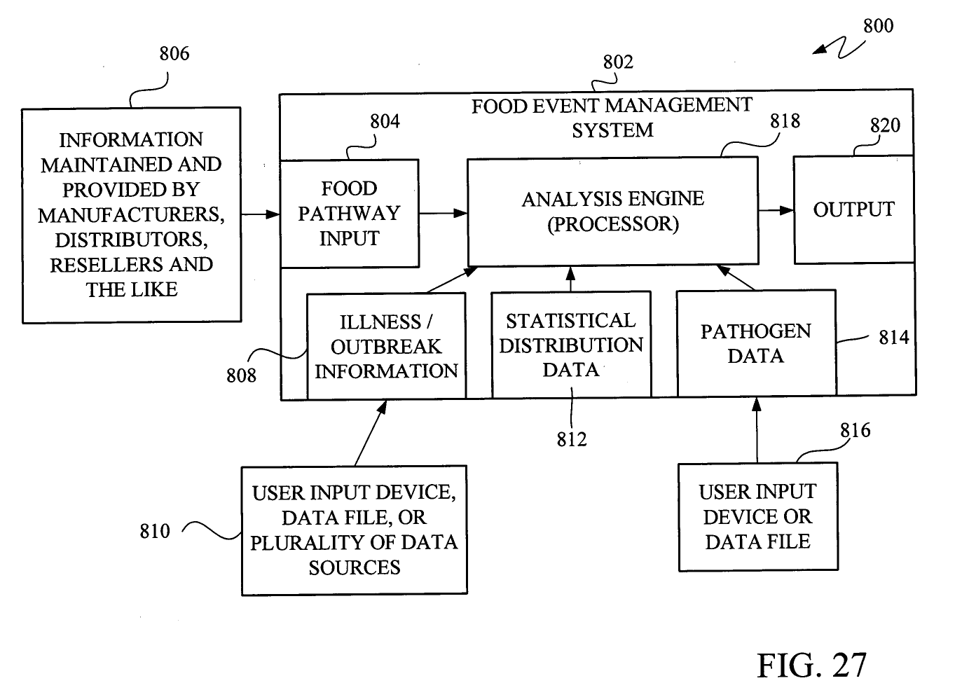

FIG. 27 is a flow diagram of an embodiment of the food event management system 802. In general, the food event management system 802 receives illness and outbreak epidemiological information (including illness type, locations, source, timing, and any other information known about the outbreak or illness) via a first food pathway input 804. The system 802 also receives food distribution pathway information via a second food pathway input 805. The food distribution pathway information may be related to the illness and outbreak information. For example, if only the locations and symptoms of the illness are known, then all possible food distributors in the areas of reported illness which carry food items capable of carrying a food-borne illness resulting in such symptoms can be received. If it is known that the food source is salmon, then the food distribution pathway information may be limited to only distributors and food services that sell salmon, and so on.

Based on the available information, the food event management system 802 generates an output, which includes possible contamination sources, locations and so on based on the statistically significant correlations between food distribution pathways and illness outbreak locations. It should be understood that the first input node 804 and the second input node 805 may be a single input, such as a network card of a computer, for example.

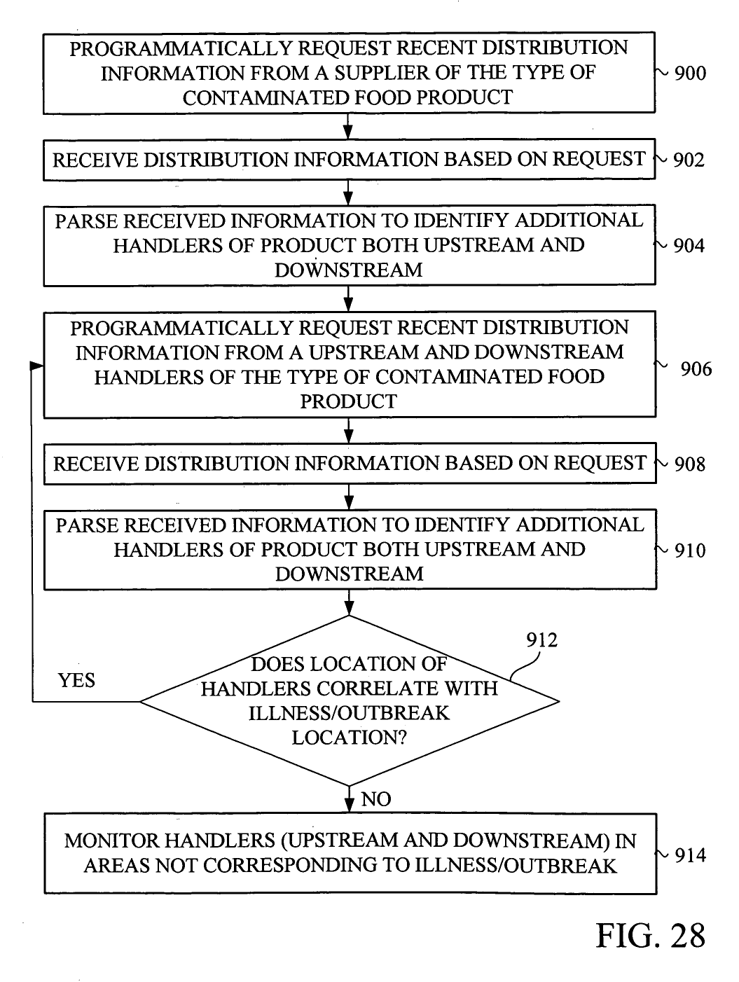

FIG. 28 is a flow diagram of a method for dynamically developing a food distribution pathway for a particular product using trace-forward and trace-back systems, such as food distribution traceforward/trace backward systems 130 in FIG. 3.

The system programmatically requests recent distribution information from a supplier of the type of contaminated food product that is determined to have made a consumer ill (block 900), or this information may be supplied voluntarily by the supplier, or may be requested independently by a third party, such as the user. The supplier supplies requested the information, which is received by the system (block 902). The system may “scrub” the information to convert it to standatd formatting and encoding, and then parses the received information to identify additional handlers of product both upstream and downstream in the food distribution pathway (block 904). In one embodiment, the supplier information includes both the distributor from which the supplier received the product (upstream handler(s)) and the food resellers, food services, and the like to which the supplier sold the product (downstream handler(s)).

The system may programmatically request recent distribution information from the upstream and downstream handlers of the type of contaminated food product (block 906), or the information may be supplied voluntarily by the supplier, or may be requested independently by a third party, such as the user. The upstream and downstream handlers provide the requested information, which is received by the system (block 908). The system may “scrub” the information to convert it to standard formatting and encoding, and then parses the handler information to identify any additional handlers of the product both upstream and downstream in the food pathway (block 910).

The system tests whether the locations of the indicated handlers of the product correlate with illness/outbreak locations (block 912). If not, then the system ends the query process for the time being, and monitors the handlers (upstream and downstream) in areas not corresponding to illness outbreak (block 914). In this way, the current distribution list has been assembled, and until additional illnesses are reported, the known contamination points have been identified. If the handler locations do correlate to illness/outbreak locations (block 912), then the system repeats blocks 906-912 until all distributors and suppliers of the product are known.

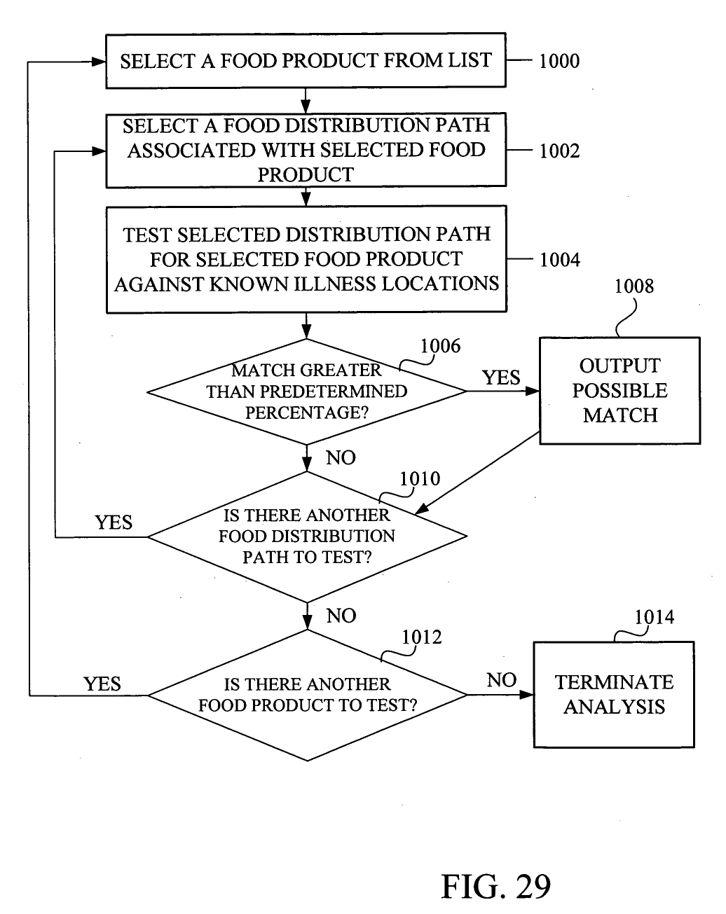

FIG. 29 is a flow diagram of a method for identifying possible sources of contamination based solely on illness outbreak locations and known distribution pathway information. This technique produces a list of the “candidates” that may provide important information, which may lead to early clues about possible illness sources and contamination points, which can be used to quickly identify and isolate a contaminated food product.

The system automatically (or programmatically based on pre-defined processor readable instructions) selects a food product from a list of food products (step 1000). The system selects a food distribution path associated with the selected food product (step 1002). The system tests the distribution path for the selected food product against known illness locations (step 1004). If the distribution path matches the illness locations to a percentage greater than a predetermined percentage (block 1006), the system generates an output of the possible match (block 1008).

The system then tests whether there is another food distribution path in the list for the selected food type (block 1010). If there is, the system repeats block 1002-1010 until all food distribution paths have been tested for the selected food product. If not, then the system tests if there are more food products in the list (block 1012). If there are more food products, the system selects another food item from the list (block 1000), and repeats steps 1002-1010 until all food distribution paths have been tested. If there are no more food products in the list (block 1012), the system terminates the analysis (block 1014), which concludes the list of possible matches. The possible matches can be used as an initial lead on possible sources of contamination, based on the degree of correlation between illness locations and food distribution paths.

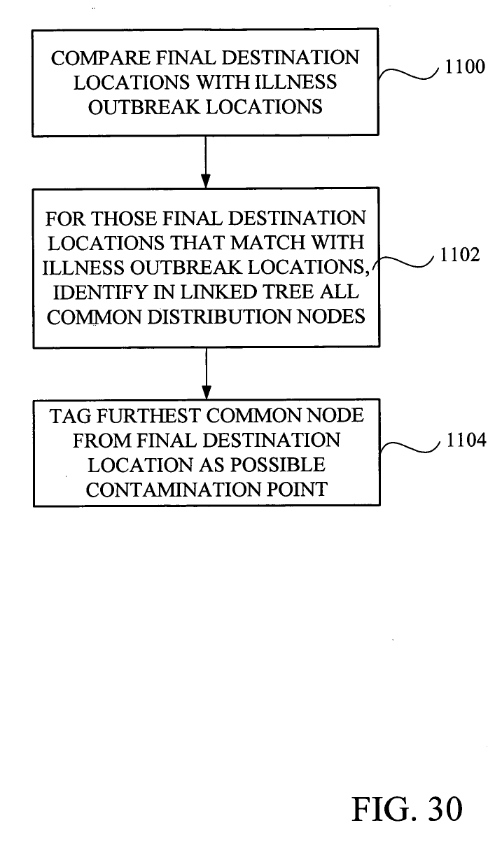

FIG. 30 is a block diagram of a method of identifying a point or source of the contamination within a food distribution path. The system compares final destination locations of the contaminated product with illness outbreak locations (block 1100). For those final destination locations that match with illness outbreak locations, the system identifies common distribution nodes within the food distribution path (block 1102). For example, referring again to element 644 in FIG. 19, each identifiable point in the food distribution path may be identified as a node. Thus, the food manufacturer is a node, the distributor is a node, and so on. By identifying the node common to all illness outbreak locations, the likely contamination source is identified.

The system then tags the common node that its analysis indicates is the possible contamination point. Frequently this is the node that is at the earliest point in the distribution pathway (block 1104). Generally, the earliest point is measured temporally, rather than in terms of geographic distance. Thus, a distributor may be further from the final destination than the regional distributor, but nevertheless not be the earliest common node in the chain.

Thus, the food event management system includes a software tool for analyzing, diagnosing and managing food contamination events. The graphical user interface of the software tool provides information in a format that is readily understandable to an ordinary user, so that even users who are unfamiliar with food distribution may be able to successfully manage and remediate a contamination event.

It should be understood by workers skilled in the art that the food event management system can be applied to any product and can be used to minimize food-borne illness in any country in the world, in select regions of a country, or even for a single manufacturer. Though in many of the figures illustrating the GUI the map represents the continental United States, the illustrations provided herein were intended for explanatory purposes, and are not intended to limit the scope of the claims. Moreover, to the extent that the system is applied to other countries, health related surveillance systems pertaining to those countries can be accessed to acquire the desired health-related information. Additionally, it should be understood that various functions and features are illustrated as separate functional components for the purposes of discussion; however, such components may be combined or integrated into a single circuit, into a single application specific processor, and/or into a software application without departing from the spirit and scope of the disclosure.

In one embodiment, a system for detecting and managing an illness outbreak caused by a food-borne agent is described. An event detection system is adapted to compare epidemiological information associated with an illness outbreak with one or more food distribution paths associated with one or more food products. The event detection system is adapted to generate an alarm if a food contamination event is detected based on a correlation between the epidemiological information and the food distribution paths.

In another embodiment, the system includes an identification system adapted to identify a contaminated food product and one or more possible contamination points within the food distribution path. The identification system is adapted to identify contaminated locations in the food distribution path for containment and remediation of a contamination event.

In another embodiment, the system includes a containment system adapted to provide user options for confining contaminated food products. The user options partially depend on information about the food-borne agent.

In another embodiment, the system includes a remediation system adapted to provide a planned approach for reducing exposure of contaminants to receptors of concern and to monitor and track steps associated with selected remediation options.

In another embodiment, the system includes one or more food-borne illness surveillance systems adapted to monitor reports of food-borne illnesses. The system also includes an illness input device coupled to the event detection system and to the one or more food-borne illness surveillance systems via a network. The illness input device is adapted to assemble the epidemiological information from the one or more food-borne illness surveillance systems.

In another embodiment, the system includes expert systems for processing the epidemiological information and the distribution path information. The expert systems are adapted to provide recommendations to the user.

In another embodiment, a system for identifying and managing an illness outbreak caused by a food-borne agent is described. The system includes an identification system adapted to identify a contaminated food product and one or more possible contamination sources within a food distribution path. The identification system is adapted to identify contaminated locations in the food distribution path for containment and remediation of a contamination event.

In another embodiment, the system includes an event detection system adapted to compare epidemiological information associated with an illness outbreak with one or more food distribution paths associated with one or more food products. The event detection system is adapted to generate an alarm if a food contamination event is detected, based on a correlation between the epidemiological information and the food distribution paths.

In one embodiment, the identification system includes a food distribution trace forward/trace backward system adapted to dynamically assemble the food distribution path for each contaminated food product from information derived from distributors of the contaminated food product. The trace forward/trace backward system may include a transceiver, a communications interface and a processor. The transceiver is adapted to communicate with one or more systems associated with the food distribution pathway. The communications interface is adapted to generate a request to the one or more systems via the transceiver. The processor is adapted to parse responses received from the one or more systems based on the request. The parser is adapted to identify upstream suppliers and downstream buyers from the parsed responses and to populate the distribution pathway information with the upstream suppliers and downstream buyers.

In another embodiment, a system for containing an illness outbreak caused by a food-borne agent includes a containment system. The containment system is adapted to provide user options for confining contaminated food products, based on epidemiological information and identified distribution information. The user options partially depend on information about the food-borne agent.

In one embodiment, the remediation options available through the system include monitoring potentially contaminated sites, removing contaminated products and equipment, destroying contaminated products and equipment, and containing contaminated products and equipment.

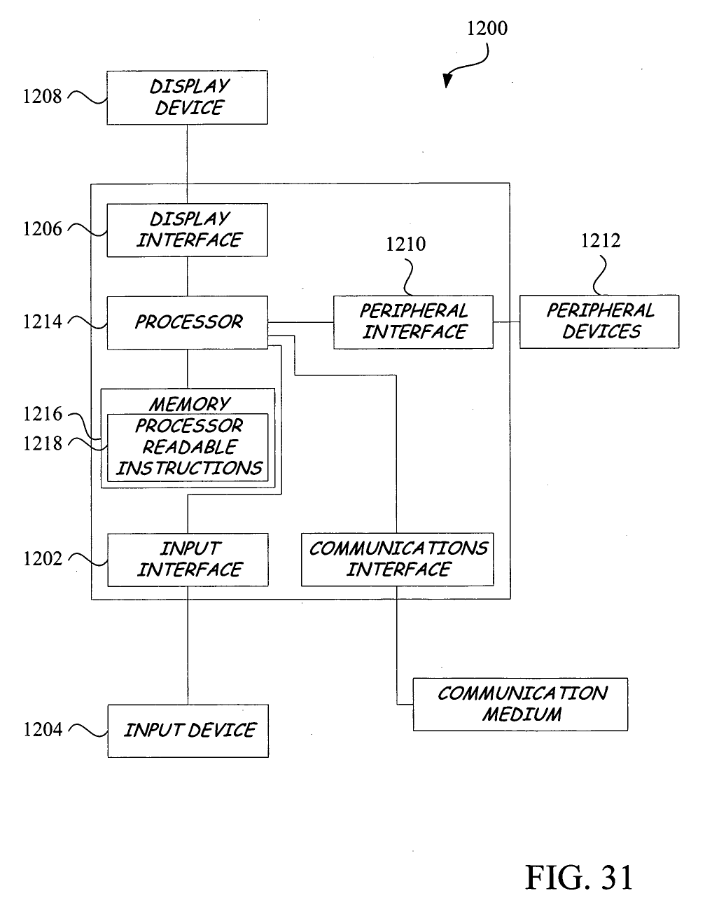

FIG. 31 is a block diagram of a processor-based system 1200 operable to generate a graphical user interface responsive to processor-readable code, which can include instructions for processing received information and for producing the graphical user interface for user interactions. The processor-based system 1200 generally includes an input interface 1202 adapted to receive inputs from an input device 1204. The input device 1204 can be a keyboard, a pen-based input, a pointer or mouse input, a tape drive, a universal serial bus flash memory, or any other type of device that can be coupled through an input interface 1202 to input information to the system 1200. The processor-based system 1200 also includes a display interface 1206 operable to transmit information to a display device 1208 for display. The system 1200 may include a peripheral interface 1210 for coupling the system 1200 to one or more peripheral devices 1212 via a wired or wireless connection. The system 1200 includes a processor 1214 and a memory 1216 adapted to store processor readable instructions 1218.

The input interface 1202 has an input connected to an input device 1204 and an output adapted to provide a signal representative of the input. The processor 1214 is coupled to the output of the input interface 1202. Additionally, the processor 1214 has bi-directional input/output ports through which the processor 1214 is connected to the memory 1216 and to the peripheral device interface 1210. Finally, the processor 1214 includes an output coupled to an input of the display interface 1206. The display interface 1206 includes an input coupled to the output of the processor 1214 and an output coupled to a display device 1208.

In general, the food event management system 102 can be operated on most processor-based systems, including computers, hand-held processing devices such as, for example, personal digital assistants, and the like. Additionally, some hand-held wireless communications devices can also be used. The food event management system 102 can include processor readable instructions, which can be read and processed to generate the graphical user interface and to populate the interface with information related to a food contamination event.

Although the food event management system has been described with reference to preferred embodiments, workers skilled in the art will recognize that changes may be made in form and detail without departing from the spirit and scope of the disclosure. For example, rather than providing information and remediation options within a graphical user interface of a software application, the user interface may be implemented as a series of HTML (Hypter-text Markup Language) pages, XML (eXtensible Markup Language) pages, or other types of Internet-based pages adapted to interact with the various subsystems. Additionally, various elements of the system may be automated or manual, depending on the specific implementation, such that the system can perform various analyses programmatically, automatically, or on request, depending on the user's preference. Moreover, each of the elements shown as separate components of the food event management system may be combined or distributed among multiple systems.

Although the present invention has been described with reference to preferred embodiments, workers skilled in the art will recognize that changes may be made in form and detail without departing from the spirit and scope of the invention.

What is claimed is:

1. An event management system comprising:
a first input node to receive epidemiological information;
a second input node to receive food distribution path information; and
a food event management system coupled to the first input node and to the second input node, the food event management system to compare the epidemiological information and the food distribution path information to identify one or more possible correlations and to generate an event output related to the one or more possible correlations.

2. The event management system of claim 1 wherein the one or more possible correlations comprise possible food contamination events.

3. The event management system of claim 1 further comprising:
a graphical user interface operable to display the event output.

4. The event management system of claim 3 wherein the graphical user interface comprises user selectable options related to the event output.

5. The event management system of claim 1 wherein the food event management system is adapted to estimate expenses related to an identified contamination event associated with a correlation of the one or more possible correlations.

6. The event management system of claim 1 further comprising:
a graphical user interface operable to display expense information related to the estimated expenses.

7. The event management system of claim 1 wherein the epidemiological information is received from at least one public health system.

8. The event management system of claim 1 wherein the food distribution path information is received from at least one node in a food distribution path.

9. The event management system of claim 8 wherein the food distribution path information is received according to an existing confidentiality agreement.

10. A processor readable medium comprising:
instructions to compare epidemiological information with food distribution path information to identify one or more possible correlations; and
instructions to generate a user interface to display the one or more possible correlations.

11. The processor readable medium of claim 10 wherein the instructions comprise a software application.

12. The processor readable medium of claim 10 wherein the epidemiological information is received from at least one health system.

13. The processor readable medium of claim 10 wherein the food distribution path information is received from at a system associated with at least one node in a food distribution path.

14. A method comprising:
receiving epidemiological information related to a plurality of reported illness incidents;
comparing the epidemiological information to a plurality of food distribution paths to identify a correlation; and
generating an event output related to the correlation.

15. The method of claim 14 wherein the event output comprises a list of locations within a particular food distribution path of the plurality of distribution paths.

16. The method of claim 14 further comprising:
comparing the epidemiological information to a plurality of food borne agents associated with food products to identify probable contaminated food products and associated agents based on the correlation.

17. The method of claim 14 wherein the epidemiological information comprises symptoms for the plurality of reported illness incidents.

18. The method of claim 14 wherein the epidemiological information comprises an identified agent associated with the plurality of reported illness incidents.

19. The method of claim 14 wherein the step of comparing comprises:
collecting information comprising the plurality of food distribution paths from one or more information sources; and
identifying one or more food distribution paths of the plurality of food distribution paths corresponding to the epidemiological information.

20. A system comprising:
an event detection system to compare epidemiological information of an illness outbreak with one or more food distribution paths, each food distribution path associated with at least one food product, the event detection system to detect a food contamination event based on a correlation between the epidemiological information and at least one of the one or more food distribution paths.

21. The system of claim 20 wherein the event detection system is adapted to generate an alarm related to the food contamination event.

22. The system of claim 20 wherein the event detection system is adapted to generate a user interface for user interactions to display food event information.

23. The system of claim 22 wherein the food event information comprises an icon indicative of the food contamination event.

24. The system of claim 22 wherein the user interface comprises user selectable options related to the food contamination event.

25. The system of claim 20 wherein the event detection system is adapted to identify at least one contaminated location in a particular food distribution path based on the correlation.

26. The system of claim 25 wherein the event detection system is adapted to provide options for remediation of the at least one contaminated location.

27. The system of claim 20 wherein the event detection system is adapted to identify a contaminated food product based on the correlation.

28. The system of claim 27 wherein the event detection system adapted to provide options for containment of the contaminated food product.

29. A system comprising:
a graphical user interface operable to display at least one reported illness incident; and
the graphical user interface operable to display food distribution information related to at least one possible food distribution path related to the illness event.

30. The system of claim 29 wherein the graphical user interface is operable to display an icon representing a severity of the at least one reported illness incident.

31. The system of claim 29 wherein the food distribution information comprises a line graph.

32. The system of claim 31 wherein the graphical user interface is operable to display a map and wherein the line graph is displayed on the map.

33. The system of claim 29 wherein the contamination event window is operable to display one or more possible contamination sources related to the at least one reported illness incident responsive to a user selection.

34. A food event detection system comprising:
a remediation system to provide remediation options responsive to an identified contamination event, the remediation system adapted to generate a list of tasks associated with each selected remediation option; and
a user interface operable to display the remediation options and the list of tasks associated with each remediation option, the user interface to allow user interaction with the remediation options and associated tasks.

35. The food event management system of claim 34 wherein the user interface allows a user to assign each task of the list of tasks associated with each remediation option to at least one entity.

36. The food event management system of claim 35 wherein the at least one entity is selected from a group consisting of an individual, a business entity, and a state-run agency.

37. The food event management system of claim 34 wherein the remediation system is adapted to track a status of each task in the list of tasks associated with a selected remediation option.

38. The food event management system of claim 37 wherein the user interface is adapted to display a status indicator associated with the status of each task.

39. The food event management system of claim 37 wherein the remediation system is adapted to generate an alarm signal related to the status of a particular task in the list of tasks.
